(19) United States
(12) Patent Application Publication
(10) Pub. No.: US 2023/0195022 A1
(43) Pub. Date: Jun. 22, 2023

(54) INFORMATION PROCESSING APPARATUS AND IMAGE FORMING SYSTEM THAT OUTPUT REPLACEMENT TIMING OF CONSUMABLE COMPONENT OF IMAGE FORMING APPARATUS

(71) Applicant: CANON KABUSHIKI KAISHA, Tokyo (JP)

(72) Inventors: KATSUHIDE KOGA, Ibaraki (JP); TAKAHIRO ONUMA, Chiba (JP)

(21) Appl. No.: 18/063,957

(22) Filed: Dec. 9, 2022

(30) Foreign Application Priority Data
Dec. 17, 2021 (JP) 2021-205470

(51) Int. Cl. G03G 15/00

(52) U.S. Cl. CPC G03G 15/556; G03G 2215/0888

(57) ABSTRACT

An apparatus is configured to obtain operating information related to an operation amount of an image forming apparatus through the communication circuit, obtain another operating information related to another operation amount of another image forming apparatus located in a same installation location at which the image forming apparatus is located, determine, based on the operating information and the another operating information, a replacement timing for replacing a consumable component used in the image forming apparatus, and output the replacement timing.

### BACKGROUND OF THE INVENTION

### Field of the Invention

The present disclosure relates to an information processing apparatus and an image forming system that output a replacement timing of a consumable component of an image forming apparatus.

### Description of the Related Art

Consumable components of an image forming apparatus (e.g., photosensitive drums, transfer belts, fixing rollers) have respective lifespans. Influence on images formed by the image forming apparatus becomes marked at the end of the lifespan of a consumable component. However, replacing a consumable component which is not at the end of its lifespan is not environmentally friendly. It is therefore important to accurately predict the replacement timings of consumable components.

According to Japanese Patent Laid-Open No. 2004-240110 and Japanese Patent Laid-Open No. 2015-132643 (corresponding to U.S. Pat. No. 9,285,743), a method is proposed which calculates the number of days remaining in the lifespan of a consumable component, according to the amount the consumable component has been used.

According to Japanese Patent Laid-Open No. 2004-240110 and Japanese Patent Laid-Open No. 2015-132643, the number of days remaining in the lifespan of a consumable component installed in an image forming apparatus is obtained from the amount the consumable component was used in the past. However, if the usage environment (location) of the image forming apparatus is changed, the accuracy of predicting the remaining number of days can drop. For example, when the change in the environment entails an old image forming apparatus being replaced by a new image forming apparatus, a log of the amounts of consumable component usage does not exist for the new image forming apparatus, and thus the accuracy of predicting the remaining number of days can drop. A similar problem arises when a new image forming apparatus is added to a given usage environment. Additionally, when a change in environment entails a user of an image forming apparatus (a department within a company or the like) changing from a given user group to another user group, the accuracy of predicting the remaining number of days can drop. This is because the amount of usages of the image forming apparatus may differ from user group to user group.

### SUMMARY OF THE INVENTION

The present disclosure is related to an information processing apparatus comprising: a communication circuit; and a controller configured to: obtain operating information related to an operation amount of an image forming apparatus through the communication circuit; obtain another operating information related to another operation amount of another image forming apparatus located in a same installation location at which the image forming apparatus is located; determine, based on the operating information and the another operating information, a replacement timing for replacing a consumable component used in the image forming apparatus; and output the replacement timing.

Further features of the present invention will become apparent from the following description of exemplary embodiments (with reference to the attached drawings).

### BRIEF DESCRIPTION OF THE DRAWINGS

FIG. 1 is a diagram illustrating a prediction system according to a first embodiment.

FIG. 2 is a diagram illustrating an image forming apparatus.

FIG. 3A is a diagram illustrating the hardware of the image forming apparatus.

FIG. 3B is a diagram illustrating a user interface.

FIG. 4 is a diagram illustrating the hardware of an information processing apparatus.

FIGS. 5A to 5C are diagrams illustrating functions implemented by a CPU according to programs.

FIG. 6A is a flowchart illustrating a lifespan data transmission method.

FIG. 6B is a diagram illustrating a data set.

FIG. 7A is a flowchart illustrating a lifespan DB management method.

FIG. 7B is a flowchart illustrating a replacement timing prediction method.

FIGS. 8A and 8B are diagrams illustrating examples of a lifespan DB.

FIG. 9A is a flowchart illustrating carryover processing.

FIG. 9B is a flowchart illustrating prediction processing.

FIGS. 10A to 10D are diagrams illustrating carryover processing.

FIG. 11 is a diagram illustrating a trend in lifespan data and a prediction method.

FIG. 12 is a diagram illustrating an example of the display of a prediction result.

FIG. 13 is a diagram illustrating a prediction system according to a second embodiment.

FIG. 14A is a diagram illustrating the hardware of an image forming apparatus according to the second embodiment.

FIG. 14B is a diagram illustrating a user interface according to the second embodiment.

FIG. 15A is a flowchart illustrating a lifespan data transmission method according to the second embodiment.

FIG. 15B is a diagram illustrating a data set.

FIG. 16A is a diagram illustrating an example of a lifespan DB according to the second embodiment.

FIG. 16B is a diagram illustrating an example of a lifespan DB according to the second embodiment.

FIG. 17 is a flowchart illustrating carryover processing according to the second embodiment.

FIGS. 18A and 18B are diagrams illustrating carryover processing.

FIGS. 19A to 19C are diagrams illustrating carryover processing.

FIG. 20 is a diagram illustrating an environment change according to a third embodiment.

FIGS. 21A and 21B are diagrams illustrating a prediction method according to the third embodiment.

FIG. 22A is a diagram illustrating the hardware of the image forming apparatus.

FIG. 22B is a diagram illustrating a user interface.

FIG. 23A is a flowchart illustrating a lifespan data transmission method according to the third embodiment.

FIG. 23B is a diagram illustrating data according to the third embodiment.

FIG. 24 is a flowchart illustrating carryover processing according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Prediction System

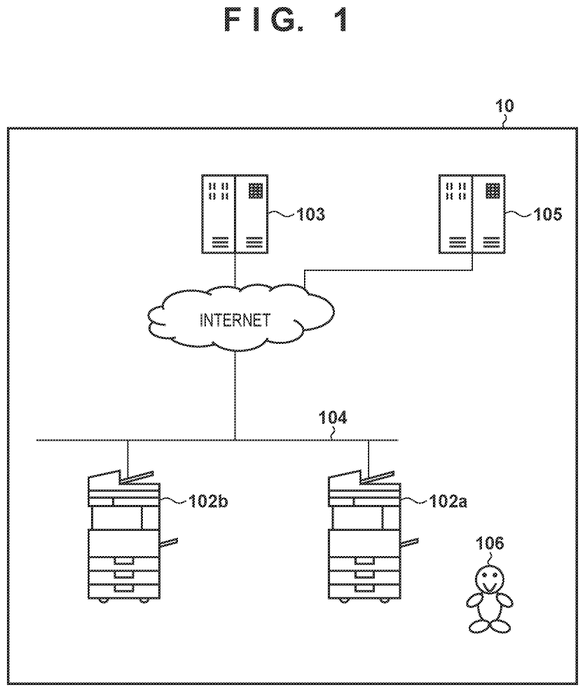

According to FIG. 1, a prediction system 10 includes a plurality of image forming apparatuses 102, a server 103, and an analysis apparatus 105, which are connected over a network 104. The number of image forming apparatuses 102 may be any number that is at least one, e.g., three or more. The prediction system 10 is a computer system that centrally manages the lifespans, operating statuses, or replacement timings of consumable components used by each of the image forming apparatuses 102. Note that when it is necessary to distinguish between multiple constituent elements, lowercase letters are added to the end of the reference signs.

The plurality of image forming apparatuses 102 upload, to the server 103, operating information (lifespan data) indicating the operating statuses and the like of the consumable components. In other words, the server 103 is an information processing apparatus that collects the lifespan data from each of the plurality of image forming apparatuses 102. The analysis apparatus 105 is an information processing apparatus that predicts the replacement timings (e.g., the number of days remaining in the lifespan, the date at which a consumable component is to be replaced, the number of sheets which an image forming apparatus can print in the life span) of the consumable components installed in each of the image forming apparatuses 102 based on the lifespan data collected from the server 103, and outputs lifespan prediction information. Note that the server 103 and the analysis apparatus 105 may be integrated.

The image forming apparatus 102 may be a multifunction peripheral (MFP) provided with a plurality of functions, such as a scan function, a print function, a copy function, and the like, for example. The image forming apparatus 102 accepts the selection of a function by a user and an instruction to execute a job for the selected function, and then executes the job. A scan job, a print job, a copy job, and the like can be given as examples of jobs. If the image forming apparatus 102 is provided with a fax function, a job that transmits and receives fax data can also be executed.

The image forming apparatus 102 is connected to the server 103 over the network 104, which includes the Internet or the like, for example, and can communicate with the server 103. When a transmission condition is satisfied, the image forming apparatus 102 transmits the lifespan data of each consumable component to the server 103. For example, the transmission condition may be every set time interval.

The server 103 receives and stores the lifespan data transmitted from each of the plurality of image forming apparatuses 102. The server 103 provides the lifespan data to the analysis apparatus 105 in response to a request from the analysis apparatus 105.

By analyzing the lifespan data of each image forming apparatus 102, the analysis apparatus 105 predicts, in advance, the date when the lifespan of each consumable component installed in the image forming apparatus 102 will end, and generates remaining days information indicating the number of days until the stated date. The analysis apparatus 105 may notify a maintenance inspector 106 of the remaining days information over the Internet or the like. The maintenance inspector 106 is, for example, a worker from the manufacturer that produced the image forming apparatus 102, the sales company that sold the image forming apparatus 102, or a company that is in the business of maintenance and inspection. Based on this notification, the maintenance inspector 106 may determine whether to make a visit for maintenance work. Note that the analysis apparatus 105 and the server 103 may be integrated.

Image Forming Apparatus

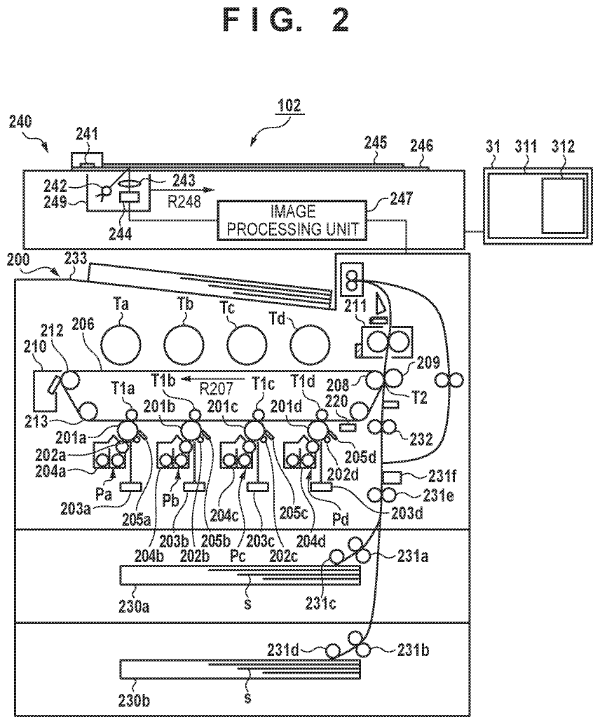

As illustrated in FIG. 2, the image forming apparatus 102 is a printer, a copier, a multifunction peripheral, a facsimile machine, or the like that forms color images using the electrophotographic method. The electrophotographic method is only one example of the image forming method, and the image forming method may be any method that requires the replacement of consumable components, such as the ink jet recording method, the thermal transfer recording method, or the like. The image forming apparatus 102 includes a printer section 200 and a reader section 240.

The printer section 200 includes four image forming units Pa to Pd, which are disposed along a rotation direction of an intermediate transfer belt 206. Storage bins 230a and 230b stack and store recording material S, which is sheets or the like, on which images are formed. Pickup rollers 231c and 231d pass the recording material S from the storage bins 230a and 230b to feed rollers 231a and 231b according to the timing of the image formation by the image forming units Pa to Pd. The feed rollers 231a and 231b are transport rollers which transport the recording material S picked up by the pickup rollers 231c and 231d along a transport path. Furthermore, the transported recording material S is transported by a pullout roller 231e and detected by a pullout sensor 231E The pullout sensor 231f detects jams of the recording material S or an arrival timing of the recording material S. A registration roller 232 is a transport roller that corrects skew in the recording material S and transports the recording material S to a secondary transfer part T2.

The printer section 200 forms images using the image forming units Pa to Pd. The image forming units Pa to Pd include photosensitive members 201a to 201d, charging units 202a to 202d, exposure units 203a to 203d, developing units 204a to 204d, primary transfer parts T1a to T1d, and photosensitive member cleaners 205a to 205d, respectively. The charging units 202a to 202d uniformly charge the surfaces of the photosensitive members 201a to 201d, respectively. The photosensitive members 201a to 201d are drum-shaped image carriers (photosensitive drums) which are rotationally driven and are irradiated by light by the exposure units 203a to 203d, respectively. The exposure units 203a to 203d irradiate the photosensitive members 201a to 201d, respectively, with light modulated according to an original image to be formed. Electrostatic latent images based on the original image are formed on the photosensitive members 201a to 201d as a result.

The developing units 204a to 204d use a developing agent to develop the electrostatic latent images formed on the photosensitive members 201a to 201d, respectively. Toner is used as the developing agent in the present embodiment. The developing units 204a to 204d develop the electrostatic latent images and form toner images by depositing toner on the photosensitive members 201a to 201d, respectively, on which the electrostatic latent images are formed. A predetermined pressure amount and electrostatic load bias are supplied to the primary transfer parts T1a to T1d, which transfer the toner images from the photosensitive members 201a to 201d to the intermediate transfer belt 206. At this time, the toner images formed on the photosensitive members 201a to 201d, respectively, are transferred onto the intermediate transfer belt 206 in an overlapping manner.

The image forming unit Pa generates a yellow toner image. The image forming unit Pb generates a magenta toner image. The image forming unit Pc generates a cyan toner image. The image forming unit Pd generates a black toner image. However, the number of colors of toner images which are formed is not limited to four. The order of colors is also not limited to yellow (Y), magenta (M), cyan (C), and black (K). In the present embodiment, the developing units 204a to 204d hold a two-component developing agent in which nonmagnetic toner and magnetic carrier are mixed, but the developing agent may be a single-component developing agent having only magnetic toner or nonmagnetic toner.

A full-color toner image is formed on the intermediate transfer belt 206 as a result of the yellow, magenta, cyan, and black toner images being transferred. The photosensitive member cleaners 205a to 205d collect toner remaining on the photosensitive members 201a to 201d following the primary transfer. Toner bottles Ta to Td are refill receptacles for the developing agent. When the amount of toner held in the developing units 204a to 204d drops below a predetermined amount, the toner bottles Ta to Td refill the developing units 204a to 204d, respectively, with toner.

The intermediate transfer belt 206 is an endless belt which is tensioned by a secondary transfer inner roller 208, a tension roller 212, and a secondary transfer upstream roller 213. The intermediate transfer belt 206 is rotationally driven in the direction of an arrow 8207 by the secondary transfer inner roller 208, the tension roller 212, and the secondary transfer upstream roller 213. The intermediate transfer belt 206, on which the full-color toner image is formed, transports the toner image to the secondary transfer part T2 by rotating.

The recording material S is transported such that the timing at which the recording material S arrives at the secondary transfer part T2 and the timing at which the toner image formed on the intermediate transfer belt 206 arrives at the secondary transfer part T2 coincide. The secondary transfer part T2 is a transfer nip part formed by the secondary transfer inner roller 208 and a secondary transfer outer roller 209, which are disposed opposing each other. The toner image is transferred onto the recording material S by applying a predetermined pressure and electrostatic load bias to the transfer nip part. A transfer cleaner 210 collects toner remaining on the intermediate transfer belt 206.

The secondary transfer outer roller 209 transports the recording material S, onto which the toner image has been transferred, from the secondary transfer part T2 to a fixing unit 211. The fixing unit 211 melts and fixes the toner image onto the recording material S by applying a predetermined pressure and amount of heat to the recording material S within a fixing nip, which is formed by opposing rollers. The fixing unit 211 includes a heater serving as a heat source, and is controlled to maintain an optimal temperature at all times. The recording material S onto which the toner image has been fixed is discharged onto a discharge tray 233. In the case of double-sided image formation, the recording material S is inverted by an inverting transport mechanism and is again transported to the registration roller 232.

A density sensor 220 for detecting the toner density is provided near the intermediate transfer belt 206. To detect a pattern of each color of toner formed on the intermediate transfer belt 206, the density sensor 220 is disposed between the photosensitive member 201d and the secondary transfer outer roller 209. Through this, the density of the toner image is kept at a proper density based on the result of the detection by the density sensor 220.

The reader section 240 is an image scanner which reads an image formed on a document 245. The document 245 is placed on a document platform 246 such that the surface on which the image is formed faces the document platform 246. The reader section 240 transmits image data, which expresses the image read from the document 245 (an original image), to the printer section 200. The reader section 240 includes a reading unit 249 and an image processing unit 247.

The reading unit 249 includes a light emitting unit 242, an optical system 243, and a light receiving unit 244. The reading unit 249 has, for example, a line sensor extending in what is the depth direction in FIG. 2, and reads the entire surface of the document 245 while moving in the direction of an arrow 8248. The light emitting unit 242 illuminates the document 245. The light receiving unit 244 receives light reflected by the document 245 through the optical system 243. A light receiving result is transmitted to the image processing unit 247. The image processing unit 247 generates image data expressing the image formed on the document 245 according to the light receiving result from the light receiving unit 244. The image processing unit 247 also functions as a sensor that measures an image density of the image formed on the document 245 according to the light receiving result from the light receiving unit 244. The image processing unit 247 transmits the image data and the measured image density to the printer section 200. A white reference plate 241 is read by the reading unit 249 when generating correction values for shading correction.

An operation panel 31 includes a display unit 311 and an operation unit 312. The display unit 311 may be constituted by a color liquid crystal display, for example, but may be constituted by a monochrome liquid crystal display. The display unit 311 displays various screens which can be manipulated by a user, information necessary for maintenance by the maintenance inspector 106, and the like. The operation unit 312 is constituted by, for example, touch panel keys located in a screen of the display unit 311. The operation unit 312 may include a numerical keypad, a user mode key, and the like.

Electrical Hardware Configuration of Image Forming Apparatus

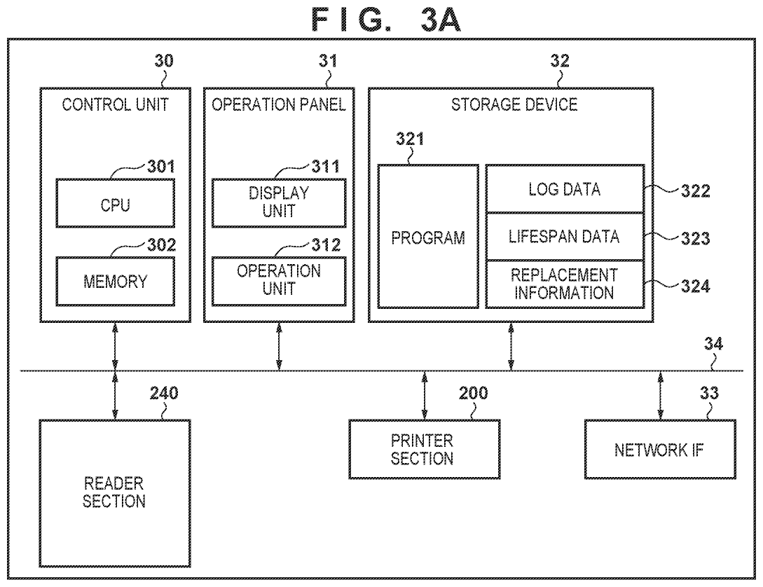

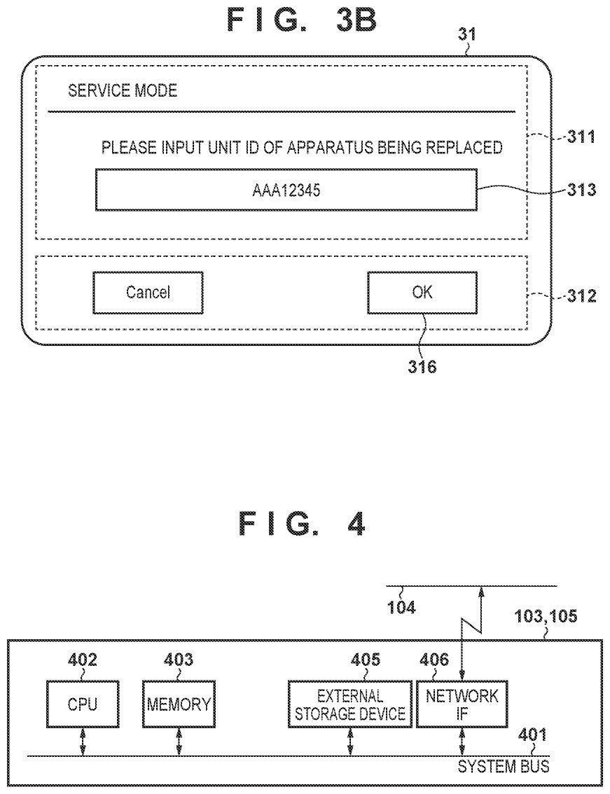

As illustrated in FIG. 3A, the image forming apparatus 102 includes a control unit 30, the operation panel 31, a storage device 32, the reader section 240, the printer section 200, and a network IF 33. Note that “IF” is an abbreviation for “interface”. These units input and output data to and from each other over a data bus 34.

The control unit 30 includes a CPU 301 and memory 302. The CPU 301 is a processor (processing circuit) capable of executing a program 321 stored in the storage device 32. When power to the image forming apparatus 102 is turned on, the CPU 301 reads out and executes the program 321 stored in the storage device 32. Through this, the CPU 301 functions as various processing units, and controls the operations of the various units of the image forming apparatus 102.

For example, in accordance with the program 321, the CPU 301 determines whether to transmit lifespan data 323 and replacement information 324 for each consumable component to the server 103 at set intervals. Upon determining to transmit the lifespan data 323 and the like, the CPU 301 generates the lifespan data 323 from log data 322. The CPU 301 transmits the lifespan data 323 to the server 103. If the replacement information 324 is stored in the storage device 32 at this time, the CPU 301 also transmits the replacement information 324 to the server 103. The replacement information 324 includes information indicating that the image forming apparatus 102 has been replaced. The memory 302 temporarily stores data necessary when the CPU 301 executes the program 321.

User Interface of Image Forming Apparatus

FIG. 3B illustrates an example of content displayed in the operation panel 31. The CPU 301 shifts to a “service mode” in response to the maintenance inspector 106 operating the operation panel 31. An input field 313 is displayed in the service mode. The input field 313 accepts the input of a unit ID of an old image forming apparatus (the apparatus being replaced) from the maintenance inspector 106. Here, an image forming apparatus having a unit ID of “AAA12345” is to be replaced. When an OK button of the operation unit 312 is pressed, the CPU 301 generates the replacement information 324, including the unit ID of the apparatus being replaced (AAA12345), and saves that information in the storage device 32.

The storage device 32 is a non-volatile storage device constituted by a hard disk drive (HDD) or the like, for example. In addition to the program 321, the storage device 32 stores the log data 322, in which operating information indicating operation amounts of consumable components (e.g., the photosensitive members 201 and the transport roller's) is recorded, the lifespan data 323 generated based on the log data 322, and the replacement information 324. The replacement information 324 includes the unit ID, which specifies the apparatus being replaced.

For example, the lifespan data 323 of a transport roller may include the ratio of a current number of transported sheets to a number of transported sheets expected to have been transported at the end of the lifespan of the transport roller (a lifetime number of sheets). The lifespan data 323 of a belt may include a ratio of a current travel distance to a travel distance expected to be reached at the end of the lifespan of the belt (a lifetime distance). In other words, assume that the lifetime number of sheets of a transport roller is 100,000 sheets, and the current number of transported sheets of the transport roller is 80,000 sheets. In this case, the lifespan data 323 is calculated as 80%. The value actually stored for the lifespan data 323 may be a value indicating 80%, or a value from which 80% can be derived.

If there is no apparatus being replaced, the replacement information 324 may be stored in a blank state, or no replacement information 324 may be stored at all.

The network IF 33 is a communication circuit for connecting the image forming apparatus 102 to the network 104. The image forming apparatus 102 communicates with the server 103 through this network IF 33.

Hardware Configuration of Information Processing Apparatus

FIG. 4 illustrates the hardware configuration of an information processing apparatus functioning as the server 103 or the analysis apparatus 105. The information processing apparatus includes a CPU 402, memory 403, an external storage device 405, and a network IF 406, which are connected to a system bus 401.

The CPU 402 is a central processing unit that controls the operations of the information processing apparatus as a whole. The CPU 402 may be called a “processor” or a “processing circuit”. The memory 403 is non-volatile and volatile memory, and stores a startup program for the CPU 402 and data used by that program. The external storage device 405 is a storage device having a higher capacity than the memory 403 (e.g., a hard disk drive (HDD)). The external storage device 405 stores a control program executed by the server 103 or the analysis apparatus 105. The external storage device 405 may be another storage device having functions equivalent to those of a hard disk drive, such as a solid-state drive (SSD) or the like.

When power to the information processing apparatus is turned on, the CPU 402 executes the startup program stored in the memory 403. The startup program reads out the control program stored in the external storage device 405 and loads the program into the memory 403. The CPU 402 executes the control program and controls the various units of the information processing apparatus in accordance with the control program. The CPU 402 writes and reads data involved in the execution of the control program to and from the memory 403. The external storage device 405 stores various settings which are necessary to execute the control program. The CPU 402 communicates with other devices on the network 104 through the network IF 406. For example, the CPU 402 receives data transmitted from the image forming apparatus 102, transmits display screen information of the operation panel 31 to the image forming apparatus 102, and the like through the network IF 406.

Logging in Image Forming Apparatus

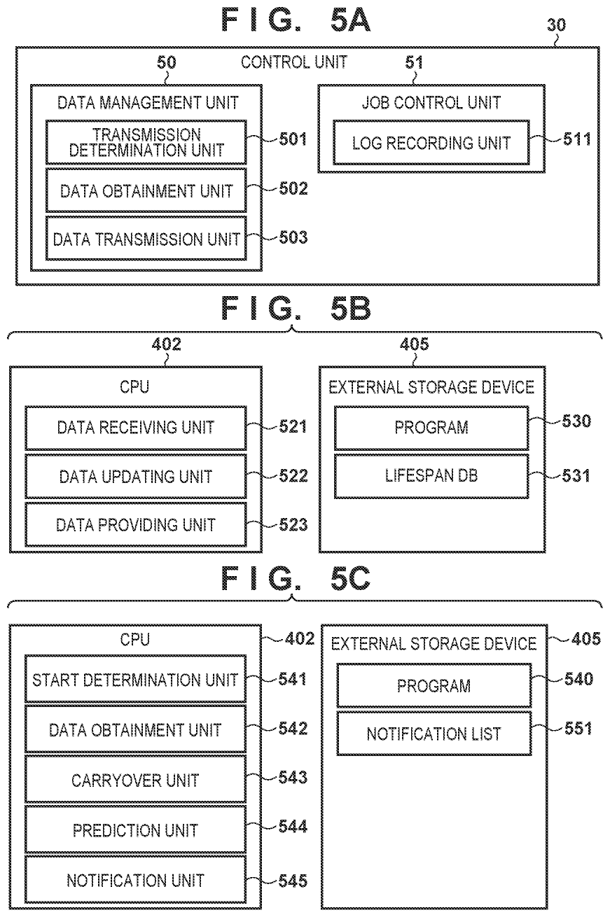

FIG. 5A illustrates functions of the control unit 30 realized by the CPU 301 of the image forming apparatus 102 executing the program 321. The control unit 30 includes a data management unit 50 and a job control unit 51. The data management unit 50 manages the lifespan data 323 of the various consumable components provided in the image forming apparatus 102. The job control unit 51 controls the execution of jobs in the image forming apparatus 102. The job control unit 51 controls the execution of jobs specified by the user and the maintenance inspector 106 by controlling the operations of the reader section 240 and the printer section 200. The job control unit 51 includes a log recording unit 511. The log recording unit 511 records an execution history of jobs in the log data 322 as the jobs specified by the user and the maintenance inspector 106 are executed.

The data management unit 50 transmits the unit ID, the lifespan data 323, and the replacement information 324 to the server 103 each time a predetermined transmission condition is satisfied. A transmission determination unit 501 determines whether the predetermined transmission condition is satisfied. A data obtainment unit 502 obtains the unit ID and the newest lifespan data 323 and replacement information 324.

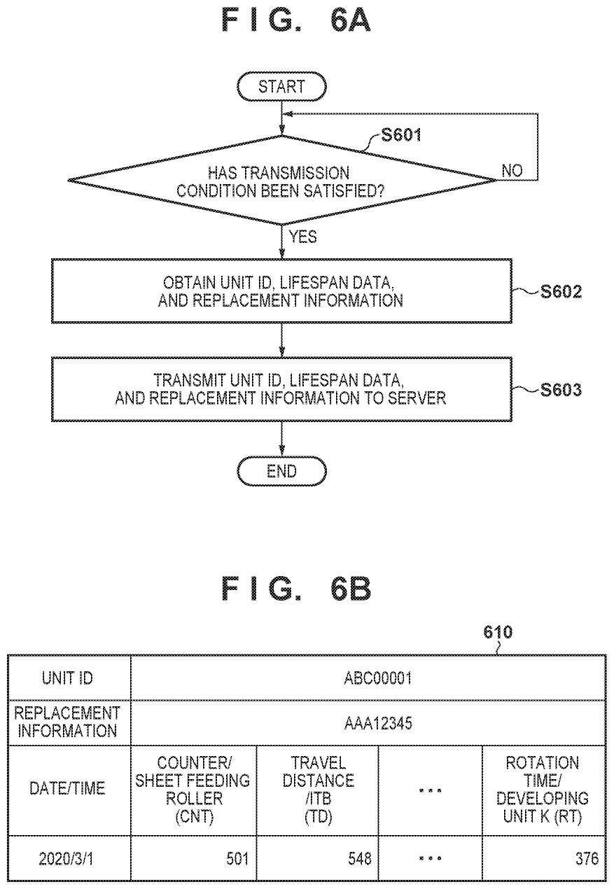

FIG. 6A illustrates processing executed by the CPU 301 in accordance with the program 321. It is assumed that steps S601 to S603 are executed repeatedly.

In step S601, the CPU 301 (the transmission determination unit 501) determines whether the predetermined transmission condition is satisfied. The transmission condition may be, for example, every set period, every day at 8:00 PM, or the like. The CPU 301 moves the processing to step S602 when the transmission condition is satisfied.

In step S602, the CPU 301 (the data obtainment unit 502) obtains the unit ID, and the newest lifespan data 323 and replacement information 324, from the storage device 32.

In step S603, the CPU 301 (a data transmission unit 503) transmits the unit ID, the lifespan data 323, and the replacement information 324 to the server 103.

FIG. 6B illustrates an example of a data set 610 transmitted to the server 103. The unit ID is identification information of the image forming apparatus 102 that transmits the data set 610. In this example, “ABC00001” is stored in the unit ID. “ABC00001” is the unit ID of a new image forming apparatus 102. The replacement information is the unit ID of the old image forming apparatus 102 which is being replaced. In this example, the unit ID of the old image forming apparatus 102 which is being replaced is “AAA12345”. “501” is input for the lifespan data (counter of feed roller (CNT)) of a feed roller. “548” is input for the lifespan data (travel distance of ITB (TD)) of the intermediate transfer belt (ITB). “376” is input for the lifespan data (rotation time of black (K) developing unit (RT)) of the black developing unit. Date/time data indicates the date/time at which this lifespan data was obtained or transmitted. In this example, “Mar. 1, 2020” is input as the date/time data. Here, the lifespan data is given in units of 0.001%. As such, “501”, which is the lifespan data of the feed roller, is interpreted as 0.501%. Likewise, the lifespan data of the ITB is interpreted as 0.548%. The lifespan data of the black developing unit is interpreted as 0.376%. These indicate a consumption rate for the lifespan at the current time, assuming a lifespan of 100% for each consumable component.

Management of Lifespan DB in Server

FIG. 5B illustrates functions realized by the CPU 402 of the server 103 executing a program 530. A data receiving unit 521 receives the unit ID, the lifespan data 323, and the replacement information 324 transmitted from the image forming apparatus 102, and stores those items in the memory 403. A lifespan DB (database) 531 is stored in the external storage device 405. The lifespan DB 531 has tables associated with unit IDs. The replacement information 324, and lifespan data 323 for each date, are registered in each table. A data updating unit 522 identifies the table associated with the received unit ID, and registers the lifespan data 323 and the replacement information 324 in that table. The lifespan data 323 and the like are added or updated as a result. A data providing unit 523 reads out data requested by the analysis apparatus 105 from the lifespan DB 531 and provides (transmits) that data to the analysis apparatus 105.

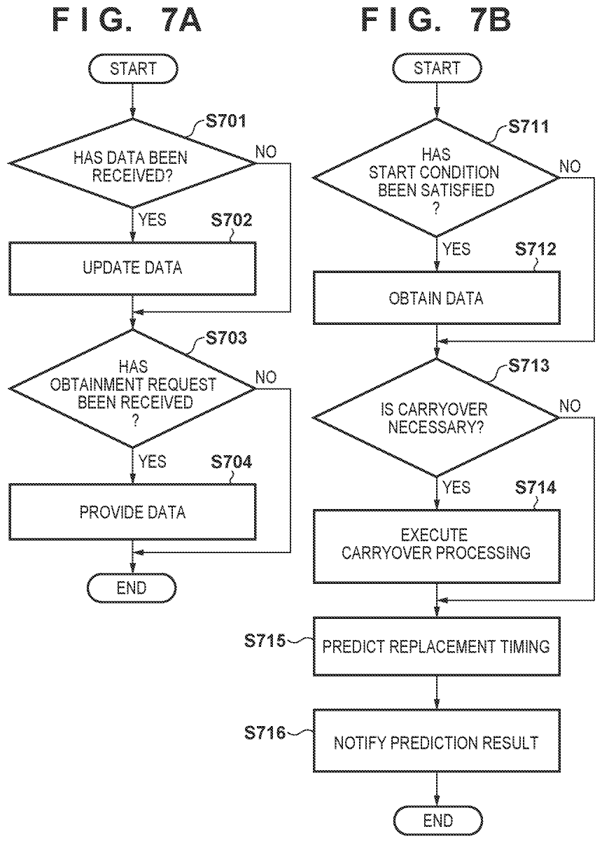

FIG. 7A illustrates processing executed by the CPU 402 of the server 103 in accordance with the program 530. It is assumed that steps S701 to S704 are executed repeatedly.

In step S701, the CPU 402 (the data receiving unit 521) determines whether the lifespan data 323 and the like has been received from any of the image forming apparatuses 102. When the lifespan data 323 and the like are received from any of the image forming apparatuses 102, the CPU 402 moves the processing to step S702. However, if the lifespan data 323 and the like are not received from any of the image forming apparatuses 102, the CPU 402 moves the processing to step S703.

In step S702, the CPU 402 (the data updating unit 522) updates the data in the lifespan DB 531 based on the lifespan data 323 and the like received from the image forming apparatus 102. For example, the CPU 402 specifies a storage location (a table, a record, or the like) within the lifespan DB 531 based on the received unit ID, and adds the lifespan data 323 and the like to the specified storage location. If the replacement information 324 has been received, the CPU 402 also stores the replacement information 324 in the storage location within the lifespan DB 531.

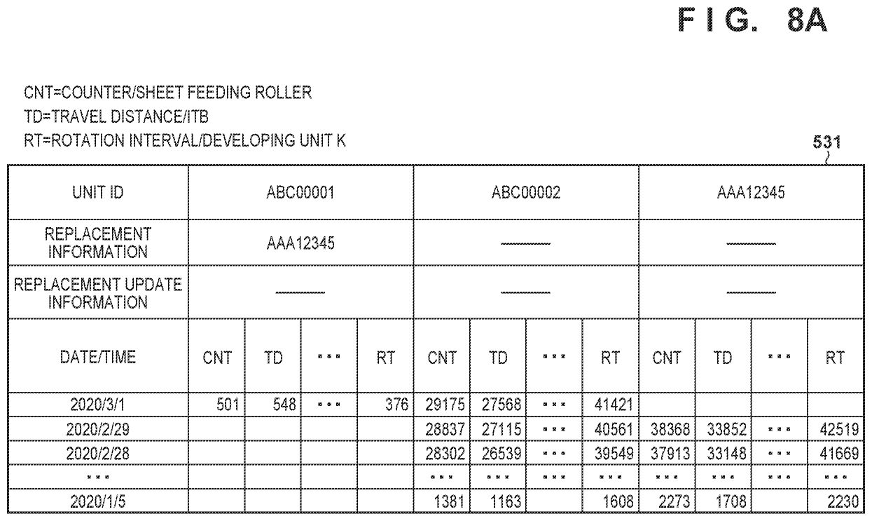

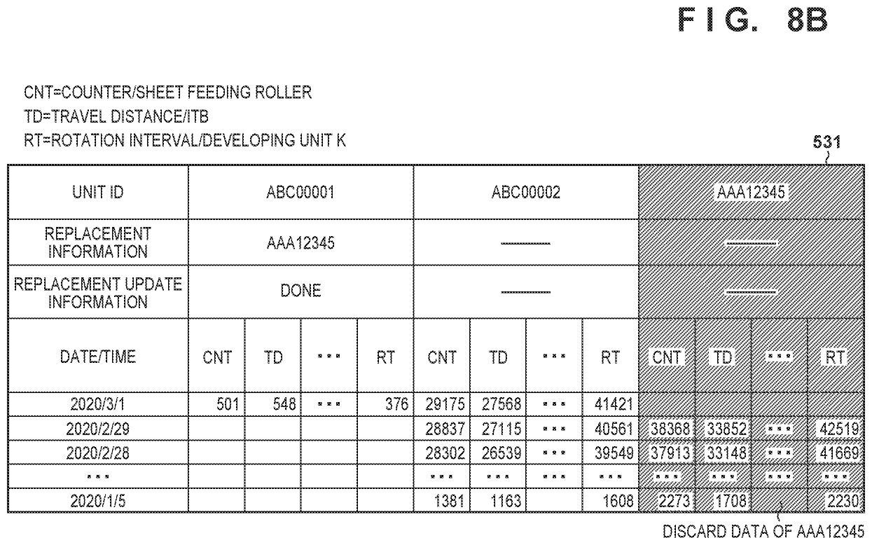

FIG. 8A illustrates an example of the lifespan DB 531. In this example, the lifespan data 323 is registered for three image forming apparatuses 102. Assume, for example, that two image forming apparatuses 102, which are identified by unit IDs of ABC00002 and AAA12345, are installed in a given environment. Assume also that in this environment, the image forming apparatus 102 identified by the unit ID of AAA12345 has been replaced by the image forming apparatus 102 identified by the unit ID of ABC00001 on Feb. 29, 2020. In this case, the image forming apparatus 102 identified by the unit ID of ABC00001 has the replacement information 324. The replacement information 324 holds the unit ID of the apparatus to be replaced, that is, AAA12345. Note that Feb. 29, 2020 may be called an “environment change date” (“replacement date”). Note that it is assumed that the image forming apparatus 102 identified by the unit ID of ABC00001 does not transmit the lifespan data 323 to the server 103 on the replacement date.

Mar. 1, 2020 is the day after the replacement date. The server 103 obtains the newest lifespan data 323 and replacement information 324 from the three image forming apparatuses 102 identified by ABC00001, ABC00002, and AAA12345, and updates the lifespan DB 531. FIGS. 8A and 8B illustrate this updated state. According to FIGS. 8A and 8B, only the image forming apparatus 102 identified by ABC00001 has AAA12345 as the replacement information 324. The other two image forming apparatuses 102 do not have the replacement information 324 (are blank). Accordingly, it can be seen from the lifespan DB 531 that the image forming apparatus 102 identified by AAA12345 has been replaced by the image forming apparatus 102 identified by ABC00001. The image forming apparatus 102 identified by AAA12345 has been removed on the replacement date, and thus for AAA12345, the lifespan data 323 is blank starting from the day after the replacement date.

In step S703, the CPU 402 (the data providing unit 523) determines whether a data obtainment request has been received from the analysis apparatus 105. When the obtainment request is received, the CPU 402 moves the processing to step S704. If no obtainment request is received, the CPU 402 skips step S704.

In step S704, the CPU 402 (the data providing unit 523) provides the data to the analysis apparatus 105. For example, the CPU 402 reads out the lifespan data 323 associated with the unit ID included in the obtainment request from the lifespan DB 531 and transmits that data to the analysis apparatus 105.

Replacement timing Prediction Processing in Analysis Apparatus

FIG. 5C illustrates functions realized by the CPU 402 of the analysis apparatus 105 executing a program 540. A start determination unit 541 determines whether a start condition, which serves as a trigger for starting lifespan prediction processing, is satisfied. The start condition is, for example, that power to the analysis apparatus 105 has been turned on, or is a set time every morning. A data obtainment unit 542 obtains the lifespan data and replacement information (replacement update information (described later)) associated with the unit ID subject to the prediction. A carryover unit 543 estimates or generates lifespan data of an image forming apparatus 102b by carrying over the lifespan data of an image forming apparatus 102a when the image forming apparatus 102a is replaced by the image forming apparatus 102b. For example, when the image forming apparatus 102b is new, no past operating information exists in the image forming apparatus 102b. Accordingly, it has been difficult to predict the replacement timing for consumable components in the image forming apparatus 102b until enough past operating information is accumulated. A similar issue exists when an additional image forming apparatus 102b is added to the environment in which the image forming apparatus 102a is installed. Also, if a user group moves from one room (where the image forming apparatus 102a is present) to another room (where the image forming apparatus 102b is present), the prediction processing for the image forming apparatus 102b becomes difficult for that user group. Accordingly, carrying over the operating information accumulated by the image forming apparatus 102a as the operating information of the image forming apparatus 102b improves the accuracy of predicting the replacement timing of consumable components in the image forming apparatus 102b. A prediction unit 544 predicts the replacement timing (lifespan expiry rate, number of remaining days, and so on) of a consumable component based on the lifespan data associated with the unit ID. A notification unit 545 transmits a replacement timing prediction result to a predetermined notification destination. A notification list 551 holds identification information of notification destinations associated with unit IDs. The identification information of a notification destination is, for example, an email address of the maintenance inspector 106, an IP address of the image forming apparatus 102, or the like. The notification unit 545 obtains, from the notification list 551, the notification destination associated with a unit ID.

FIG. 7B illustrates processing executed by the CPU 402 of the analysis apparatus 105 in accordance with the program 540. It is assumed that steps S711 to S716 are executed repeatedly.

In step S711, the CPU 402 (the start determination unit 541) determines whether a predetermined start condition is satisfied. The start condition is a condition pertaining to the timing for predicting the replacement timing. The start condition may be different for each image forming apparatus 102, or may be the same. If the start condition is satisfied, the CPU 402 moves the processing to step S712. If the start condition is not satisfied, the CPU 402 moves the processing to step S713.

In step S712, the CPU 402 (the data obtainment unit 542) accesses the server 103 and obtains data necessary for prediction. The necessary data is, for example, the unit ID, the lifespan data 323, the replacement information 324, the replacement update information (described later), and the like.

In step S713, the CPU 402 (the carryover unit 543) determines whether data carryover (handover) processing is necessary based on the data obtained from the server 103. For example, data carryover processing is necessary if an environment change has occurred for the image forming apparatuses 102 (e.g., a replacement, an addition, a change in users). For example, the data carryover processing is determined to be necessary if the image forming apparatus 102 subject to the prediction has the replacement information 324. If the data carryover processing is necessary, the CPU 402 moves the processing to step S714. If the data carryover processing is not necessary, the CPU 402 moves the processing to step S715.

In step S714, the CPU 402 (the carryover unit 543) executes the data carryover processing. For example, the CPU 402 obtains, from the server 103, the lifespan data 323 of the image forming apparatus 102 being replaced, based on the unit ID of the apparatus being replaced included in the replacement information 324. The CPU 402 offsets the data from before the replacement date such that the data from before the replacement date and the data from after the replacement are seamlessly connected. The “data from after the replacement” is the lifespan data 323 obtained by the replacement image forming apparatus 102. “Seamlessly connected” means that there is only a small difference between the data from before the replacement date and the data from after the replacement. In this manner, “seamlessly connected” means that there is continuity between the data from before the replacement date and the data from after the replacement.

In step S715, the CPU 402 (the prediction unit 544) predicts the replacement timing of a consumable component based on the lifespan data 323 obtained from the server 103. If the carryover processing has been executed, the CPU 402 predicts the replacement timing of the consumable component based on the seamless lifespan data 323 generated through the carryover processing.

In step S716, the CPU 402 (the notification unit 545) notifies the predetermined notification destination of the replacement timing prediction result. The identification information of the predetermined notification destination may be obtained from the notification list 551.

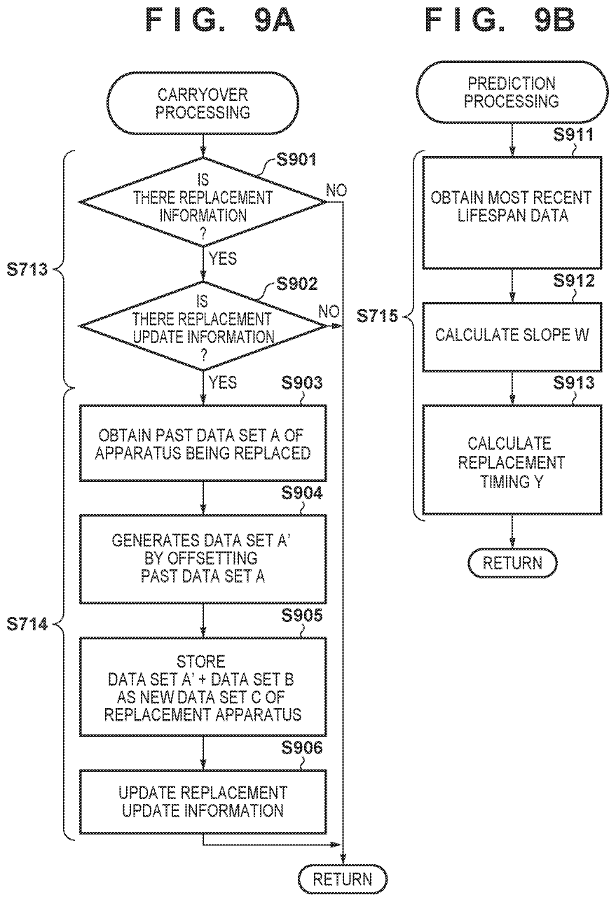

FIG. 9A illustrates a detailed example of the carryover processing (replacement processing) performed in steps S713 and S714. It is assumed here that the apparatus having a unit ID of ABC00001, illustrated in FIG. 8A, is subject to prediction.

In step S901, the CPU 402 (the carryover unit 543) determines whether the replacement information 324 is present in the data set obtained from the server 103 for the image forming apparatus 102 subject to the prediction. If there is no replacement information 324 present, the carryover processing is not necessary, and the CPU 402 therefore moves the processing to step S715. However, if the replacement information 324 is present, the carryover processing is necessary, and the CPU 402 therefore moves the processing to step S902.

In step S902, the CPU 402 (the carryover unit 543) determines whether replacement update information is present. The replacement update information being present indicates that the replacement processing has been executed once in the past. According to FIG. 8A, the replacement update information associated with the unit ID of ABC00001 is blank, which means that the replacement processing has not been executed even once for the unit ID of ABC00001. If there is no replacement update information present, the replacement processing is necessary, and the CPU 402 therefore moves the processing to step S903. However, if the replacement update information is present, the replacement processing is not necessary, and the CPU 402 therefore moves the processing to step S715.

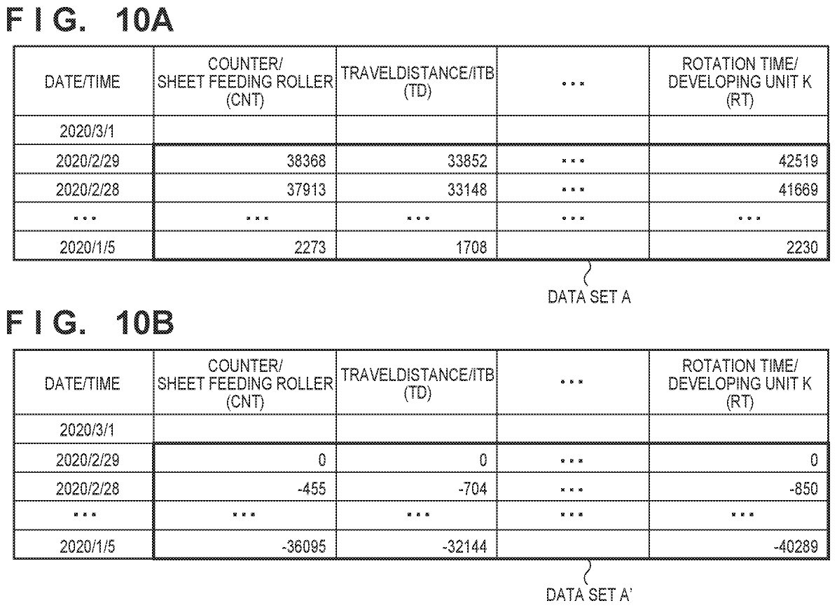

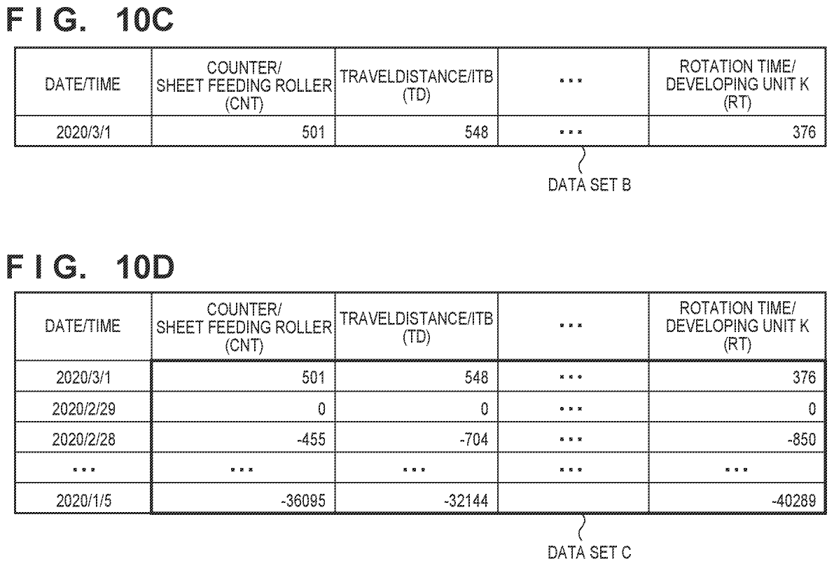

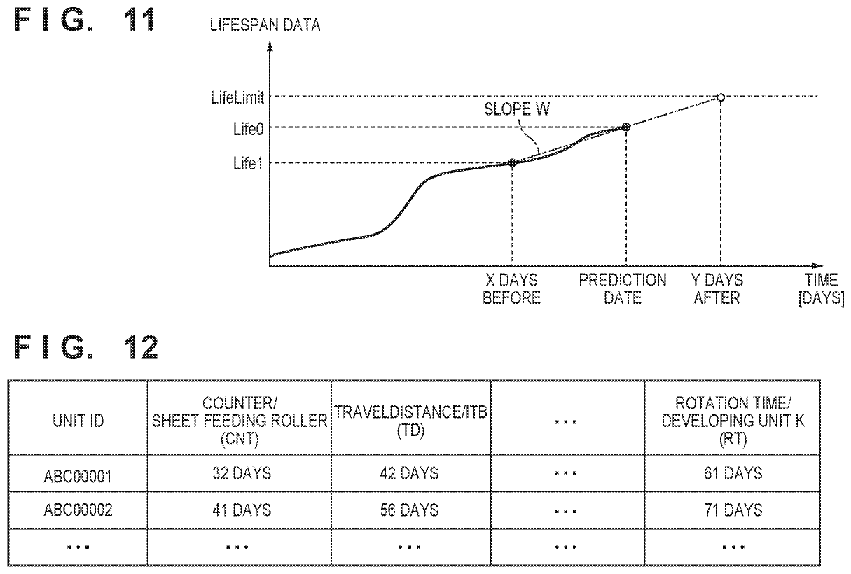

In step S903, the CPU 402 (the carryover unit 543) obtains a past data set A of the apparatus being replaced. The CPU 402 obtains the unit ID of the apparatus being replaced, included in the replacement information 324 of the replacement apparatus, and transmits a data obtainment request with the unit ID of the apparatus being replaced to the server 103. Note that the data obtainment request may include period information specifying the data from before the replacement date. Here, the data from before the replacement date is referred to as the past data set A. FIG. 10A illustrates an example of the past data set A in the lifespan DB.

In step S904, the CPU 402 (the carryover unit 543) generates a data set A′ by offsetting the past data set A. FIG. 10B illustrates an example of the data set A′. Here, the data set A′ is generated from the data set A such that the lifespan data 323 is 0 for each consumable component on the replacement date. For example, the lifespan data of the feed roller on the replacement date (Feb. 29, 2020) is offset from 38368 to 0. In other words, the offset amount is −38368. Similarly, the lifespan data for Feb. 28, 2020 is offset to −455 (37913−38368=−455). The remaining lifespan data in the data set A is similarly offset based on offset amounts. Although the lifespan data of the replacement apparatus is assumed to be 0 on the replacement date, the lifespan data may have a value aside from 0. In this case, the offset amount is calculated according to the lifespan data of the replacement apparatus on the replacement date. For example, if the lifespan data of the replacement apparatus on the replacement date is 10, the offset amount is −38358 (10−38368=−38358). In other words, the image forming apparatus 102 which is the replacement apparatus need not be new.

In step S905, the CPU 402 (the carryover unit 543) generates a data set C of the replacement apparatus. For example, the CPU 402 generates the data set C illustrated in FIG. 10D by combining the data set A′ of the apparatus being replaced, illustrated in FIG. 10B, and a data set B of the replacement apparatus, illustrated in FIG. 10C. As a result, the data set C of the replacement apparatus becomes a data set having continuity between before and after the replacement date. The data set C is held in the memory 403 for the prediction processing. Alternatively, the data set C may be transmitted to the server 103 and registered in the lifespan DB 531.

In step S906, the CPU 402 (the carryover unit 543) updates the replacement update information of the replacement apparatus (unit ID=ABC00001) to “done” in the lifespan DB 531. This is executed by transmitting an update request to the server 103. Additionally, as illustrated in FIG. 8B, the CPU 402 (the carryover unit 543) requests the server 103 to discard the data of the apparatus being replaced (unit ID=AAA12345). By setting the replacement update information to “done”, the replacement processing will not be executed the next time. Note that rather than discarding the data of the apparatus being replaced (unit ID=AAA12345), information indicating that the apparatus has been replaced may be associated with the data of the apparatus being replaced (unit ID=AAA12345).

FIG. 9B illustrates a detailed example of the prediction processing performed in step S715. FIG. 11 illustrates trends in the lifespan data of a consumable component. The horizontal axis represents time (in days), and the vertical axis represents the lifespan data.

In step S911, the CPU 402 (the prediction unit 544) obtains the most recent lifespan data associated with the unit ID subject to the prediction. For example, lifespan data Life0 on the prediction date and lifespan data Life1 X days before the prediction date are obtained from the memory 403. Lifespan data for at least three days may be obtained in order to calculate a slope W. Note that the “prediction date” is the date on which the prediction processing is executed.

In step S912, the CPU 402 (the prediction unit 544) calculates the slope W based on the most recent lifespan data (e.g., the lifespan data Life0 and Life1). The slope W expresses the lifespan advancement degree from the prediction date to X days previous, and is indicated by a dot-dash line in FIG. 11.

W=(Life0−Life1)/X Eq. 1

In step S913, the CPU 402 (the prediction unit 544) calculates the replacement timing (a number of remaining days Y) based on the slope W.

Y=(LifeLimit−Life0)/W Eq. 2

Here, LifeLimit represents the design lifespan of the consumable component. The design lifespan LifeLimit is assumed to be stored in the external storage device 405 of the analysis apparatus 105 or the server 103 in advance. It is assumed here that the lifespan advancement degree (the slope W) before the prediction date and the lifespan advancement degree (the slope W) after the prediction date are the same, and this is considered to be empirically correct.

FIG. 12 illustrates a replacement timing prediction result communicated to the maintenance inspector 106 or the like. Here, the replacement timing is expressed as the number of days remaining in the lifespan. The replacement timing may be converted into a specific year, month, and day.

In this manner, according to the first embodiment, the replacement timing of a consumable component can be predicted even when the past operating information necessary for prediction is insufficient. Such insufficiencies arise primarily due to changes in the environment related to the image forming apparatus 102. For example, an old image forming apparatus 102 being replaced with a new image forming apparatus 102 is an example of a change in the environment. Accordingly, carrying over operating information obtained for the old image forming apparatus 102 to the new image forming apparatus 102 before the replacement makes it possible to make predictions about the new image forming apparatus 102.

### Second Embodiment

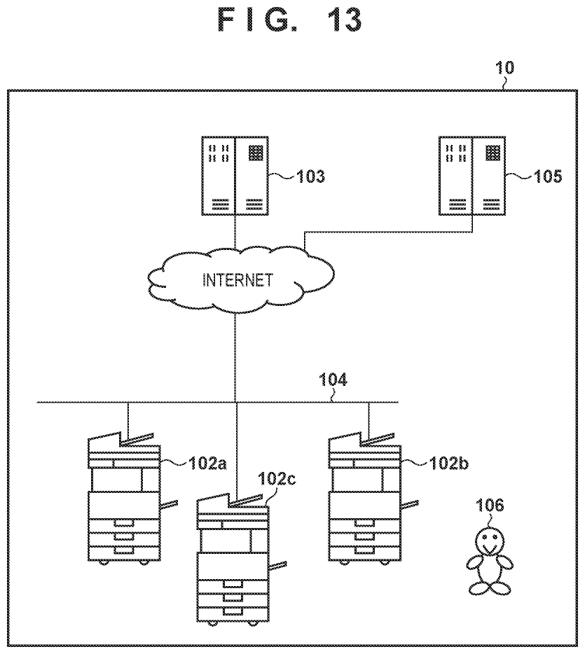

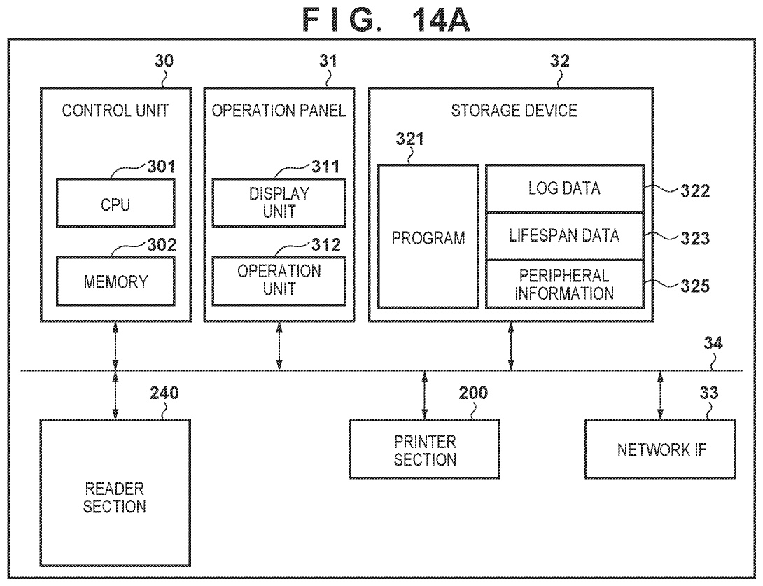

A second embodiment will describe an example in which an image forming apparatus 102 is added as an example of an environment change. FIG. 13 illustrates a new image forming apparatus 102c being added to the prediction system 10 illustrated in FIG. 1. The unit ID of the image forming apparatus 102c is ABC00001. The unit ID of the image forming apparatus 102a is AAA12345. The unit ID of the image forming apparatus 102b is AAA67890. Note that items already described in the first embodiment will not be described here.

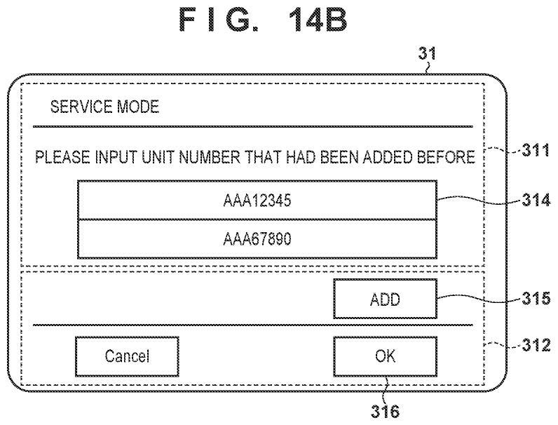

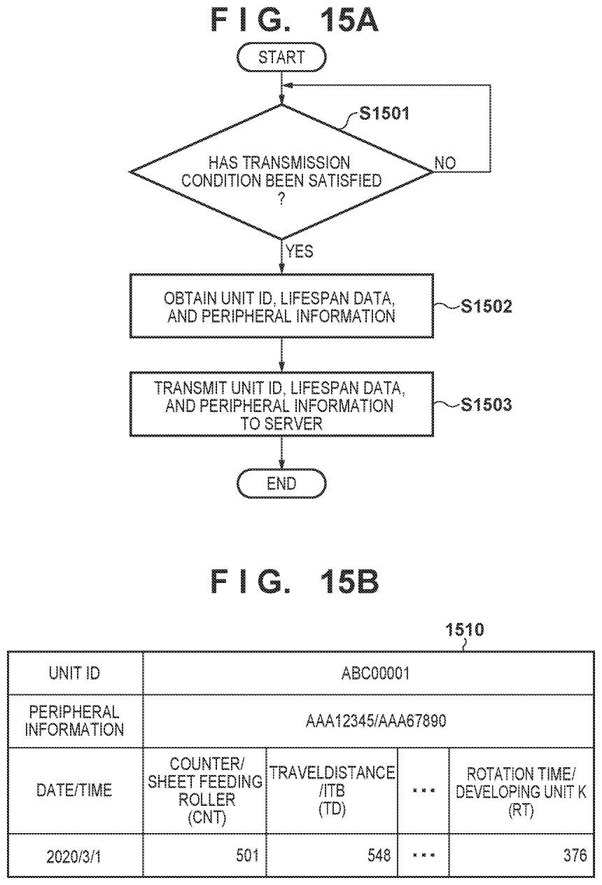

FIG. 14A illustrates the hardware configuration of the image forming apparatuses 102. The CPU 301 determines whether to transmit the lifespan data 323 and peripheral information 325 to the server 103 in accordance with the program 321. When the transmission condition is satisfied, the CPU 301 generates the lifespan data 323 from the log data 322 and transmits the lifespan data 323 to the server 103. At this time, if the peripheral information 325 is stored in the storage device 32, the CPU 301 also transmits the peripheral information 325 to the server 103. Here, the peripheral information 325 is the unit IDs and the like of the other image forming apparatuses 102 already operating in an environment when a given image forming apparatus 102 is added to that environment.

FIG. 14B illustrates an example of content displayed in the operation panel 31 according to the second embodiment. The display unit 311 displays, to the maintenance inspector 106, guidance and an input field 314 for inputting the peripheral information 325. When an add button 315 displayed in the operation unit 312 is pressed, the CPU 301 adds the input field 314. In this example, two input fields 314 are displayed, and the unit IDs of the other image forming apparatuses 102 already operating in that environment are already input from before the addition of the new image forming apparatus 102. In this example, the unit IDs of AAA12345 and AAA67890 are input. When an OK button 316 is pressed, the CPU 301 stores the unit IDs input into the input fields 314 (AAA12345, AAA67890) in the peripheral information 325, and stores the peripheral information 325 in the storage device 32.

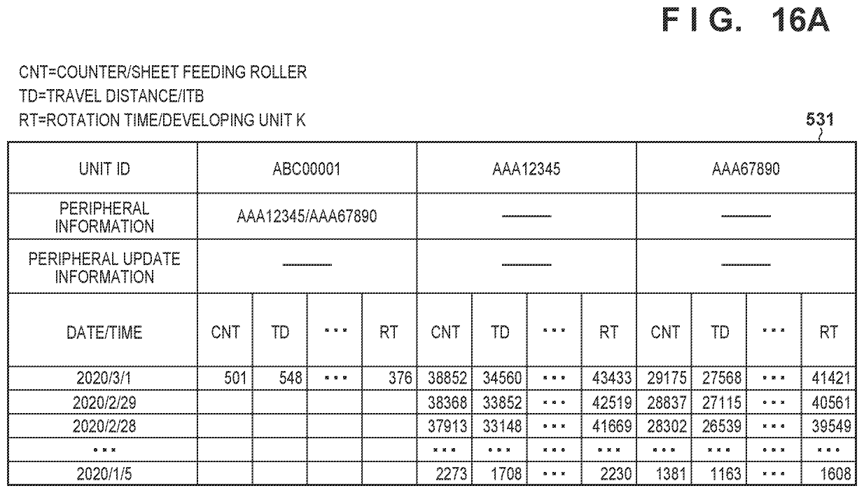

FIG. 15A illustrates a transmission method for a data set including the unit ID, the lifespan data 323, and the peripheral information 325. In step S1501, the CPU 301 (the transmission determination unit 501) determines whether the predetermined transmission condition is satisfied. The transmission condition may be, for example, every set period, every day at 8:00 PM, or the like. The CPU 301 moves the processing to step S1502 when the transmission condition is satisfied. In step S1502, the CPU 301 (the data obtainment unit 502) obtains the unit ID, and the newest lifespan data 323 and peripheral information 325, from the storage device 32. In step S1503, the CPU 301 (a data transmission unit 503) transmits the unit ID, the lifespan data 323, and the peripheral information 325 to the server 103.

FIG. 15B is an example of a data set 1510 transmitted to the server 103. The data set 1510 includes the unit ID, the lifespan data 323, and the peripheral information 325 of the image forming apparatus 102 that transmits the data set 1510 to the server 103. In this example, the unit ID of the image forming apparatus 102c is ABC00001. The peripheral information 325 includes the unit IDs of the image forming apparatuses 102a and 102b installed in the periphery of the image forming apparatus 102c, i.e., AAA12345 and AAA67890. The lifespan data 323 includes a cumulative operation amount of each consumable component, and an obtainment date/time of the lifespan data 323.

The operations of the server 103 according to the second embodiment are almost the same as the operations of the server 103 according to the first embodiment. In other words, the only difference is that the peripheral information 325 is received, registered, and provided instead of the replacement information 324. The operations of the analysis apparatus 105 according to the second embodiment are almost the same as the operations of the analysis apparatus 105 according to the first embodiment. Accordingly, parts specific to the second embodiment will be described in detail hereinafter.

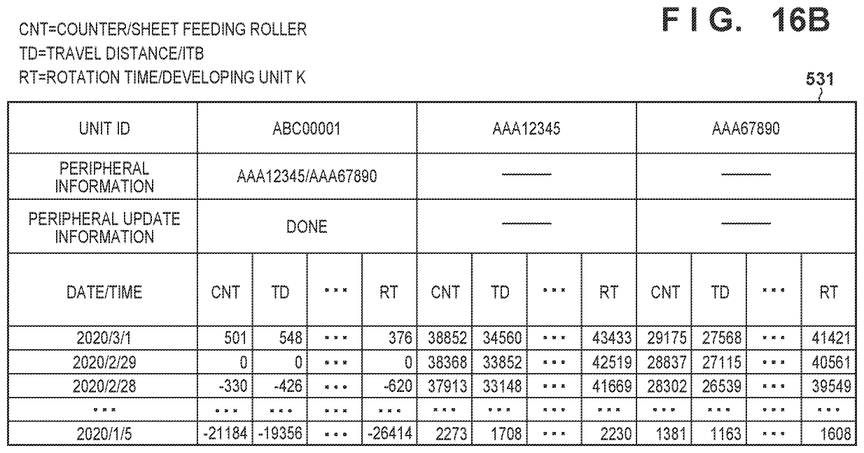

FIG. 16A illustrates an example of the lifespan DB 531. The lifespan data 323, the date/time the lifespan data 323 was obtained, the peripheral information 325, and peripheral update information, each associated with a unit ID, are registered in the lifespan DB 531. The peripheral update information is information indicating whether carryover of the lifespan data 323 will be executed in accordance with the addition of the image forming apparatus 102.

As one example, the image forming apparatus 102c, which has a unit ID of ABC00001, is added to a location where the image forming apparatus 102a and the image forming apparatus 102b, which have unit IDs of AAA12345 and AAA67890, respectively, are being used. The date on which the image forming apparatus 102c was added (an addition date) is Feb. 29, 2020.

The server 103 obtains the newest lifespan data and peripheral information from the three image forming apparatuses 102 identified by ABC00001, AAA12345, and AAA67890 the day after the addition date (Mar. 1, 2020). The server 103 adds the obtained newest lifespan data (the data from Mar. 1, 2020) to the past data (the data prior to Feb. 29, 2020). FIG. 16A illustrates the lifespan DB 531 after the addition of data is complete.

According to FIG. 16A, AAA12345 and AAA67890 are registered as the peripheral information 325 only for the apparatus having a unit ID of ABC00001. It can be seen that the image forming apparatus 102 identified by the unit ID of ABC00001 has been added to the location where the two image forming apparatuses 102, identified by the unit IDs of AAA12345 and AAA67890, are being used.

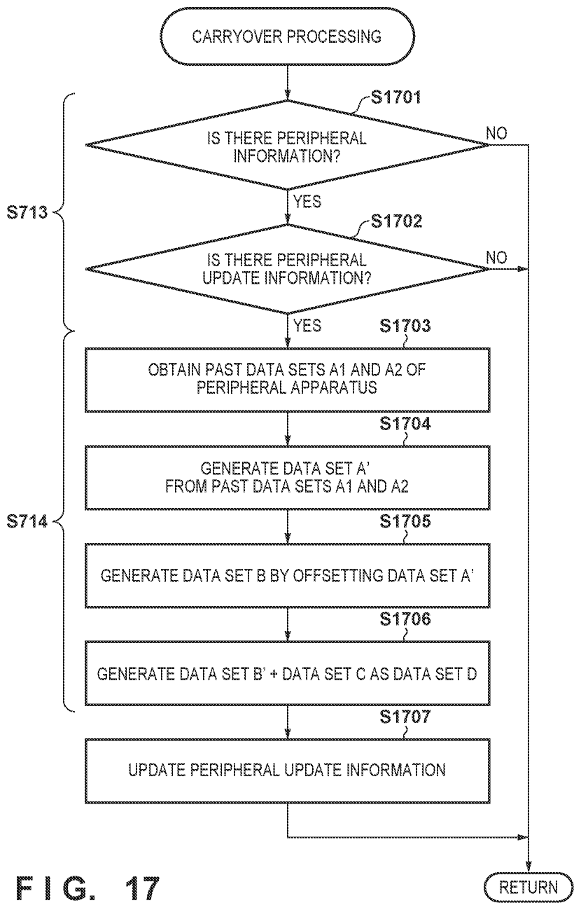

The prediction method performed by the analysis apparatus 105 is the same as that in FIG. 7B. However, the details of steps S713 and S714 are different. FIG. 17 illustrates the carryover processing according to the second embodiment.

In step S1701, the CPU 402 (the carryover unit 543) determines whether the peripheral information 325 is present in the data set obtained from the server 103 for the image forming apparatus 102 subject to the prediction. If there is no peripheral information 325 present, the carryover processing is not necessary, and the CPU 402 therefore moves the processing to step S715. If the peripheral information 325 is present, the CPU 402 moves the processing to step S1702.

In step S1702, the CPU 402 (the carryover unit 543) determines whether peripheral update information is present. The peripheral update information being present indicates that the carryover processing has been executed once in accordance with an apparatus being added. According to FIG. 16A, the peripheral update information associated with the unit ID of ABC00001 is blank, which means that the carryover processing has not been executed even once for the unit ID of ABC00001. If the peripheral update information is blank, the carryover processing is necessary, and the CPU 402 therefore moves the processing to step S1703. If peripheral update information is present, the carryover processing is not necessary, and the CPU 402 therefore moves the processing to step S715.

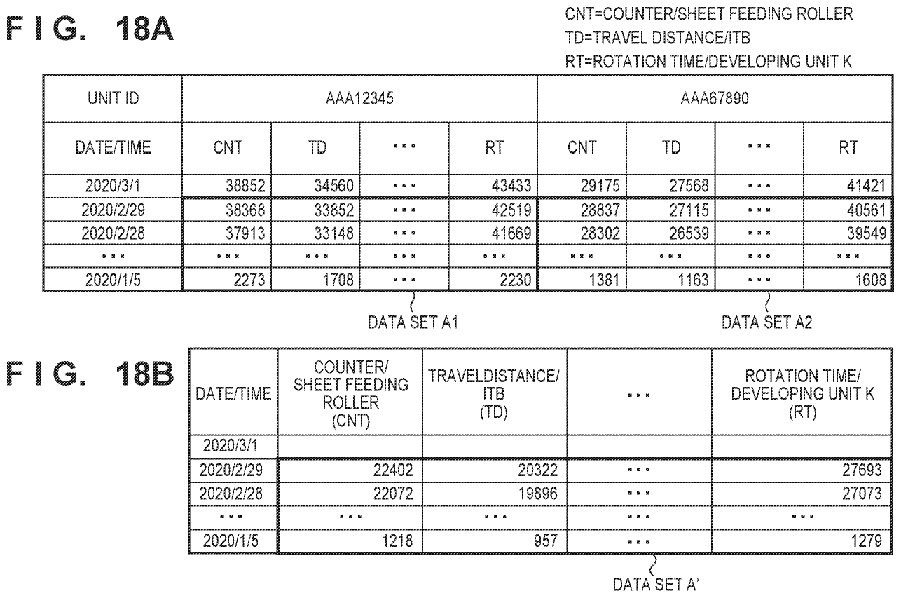

In step S1703, the CPU 402 (the carryover unit 543) obtains past data sets A1 and A2 of the peripheral apparatuses. For example, the CPU 402 obtains the unit IDs of the peripheral apparatuses indicated by the peripheral information 325, and transmits a data obtainment request with the unit IDs of the peripheral apparatuses to the server 103. Note that the data obtainment request may include period information specifying the data from before the addition date. Here, the data from before the addition date is called the past data sets A1 and A2. FIG. 18A illustrates an example of the past data sets A1 and A2 in the lifespan DB 531. The data set A1 is constituted by the lifespan data 323 of the image forming apparatus 102a from before the addition date. The data set A2 is constituted by the lifespan data 323 of the image forming apparatus 102b from before the addition date. The data sets A1 and A2 obtained from the server 103 are stored in a work area of the memory 403.

In step S1704, the CPU 402 (the carryover unit 543) generates a data set A′ from the past data sets A1 and A2. For example, the CPU 402 adds the lifespan data 323 of each consumable component from the data sets A1 and A2 for each date to obtain a sum, divides the sum by the number of image forming apparatuses 102 following the addition, and rounds the resulting value off. The reason for dividing by the number of image forming apparatuses 102 following the addition is to distribute the workload in that environment.

FIG. 18B illustrates the data set A′. On Feb. 29, 2020, a counter for the feed roller having the unit ID of AAA12345 is 38368, and the counter for the feed roller having the unit ID of AAA67890 is 28837. The sum is therefore 67205. Dividing this sum by 3, which is the number of apparatuses after addition, and rounding off the result gives 22402 as the counter of the feed roller in the data set A′. Similarly, the counter for the feed roller on Feb. 28, 2020 in the data set A′ is 22072.

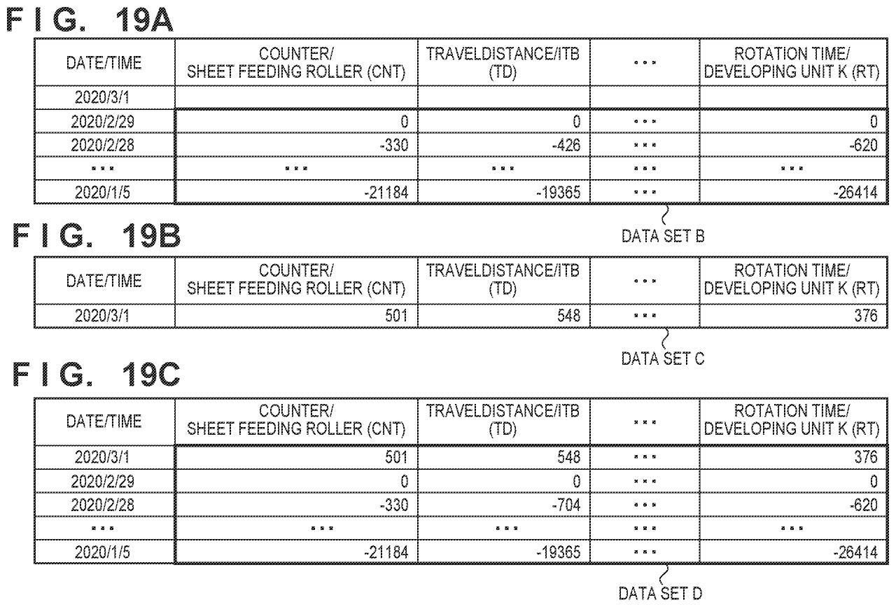

In step S1705, the CPU 402 (the carryover unit 543) generates a data set B by offsetting the data set A′. FIG. 19A illustrates an example of the data set B. The CPU 402 obtains an offset amount such that the lifespan data 323 on the addition date becomes 0, and generates the data set B by offsetting the data set A′ by that offset amount. The offset method according to the second embodiment is basically the same as the offset method according to the first embodiment.

In step S1706, the CPU 402 (the carryover unit 543) generates a data set D by combining the data set B with the data set C. FIG. 19B illustrates the data set C obtained from the lifespan DB 531. The data set C is constituted by the lifespan data 323 of the image forming apparatus 102c which has been added, from the day after the addition date. FIG. 19C illustrates the data set D. The data set D is generated by merging the data set B from before the addition date with the data set C from the day after the addition date. The data set D is stored in the memory 403 or the lifespan DB 531 as new lifespan data of the image forming apparatus 102c which has been added (unit ID=ABC00001).

In step S1707, the CPU 402 (the carryover unit 543) updates the peripheral update information of the image forming apparatus 102c which has been added (unit ID=ABC00001) from being blank to “done”. FIG. 16B illustrates the lifespan DB 531 in a state in which the carryover processing is complete. The peripheral update information of the image forming apparatus 102c (unit ID=ABC00001) has been updated to “done”.

In this manner, the lifespan data of the image forming apparatuses 102a and 102b already being used is carried over to the image forming apparatus 102c that has been newly added. The lifespan data carried over also takes into account the effect of distributing the load of printing processing involved with the increase in the number of image forming apparatuses 102. Accordingly, even if an environment change occurs in which an image forming apparatus 102 is added, the replacement timing of consumable components can be predicted accurately.

### Third Embodiment

An example of the environment change according to a third embodiment is an environment change caused by a change in a user group using the image forming apparatus 102. The user group may be constituted by a single user, or by a plurality of users. The amount of usage of an image forming apparatus 102 may vary significantly from one user group to another user group. In this case, changing the user group will change the date of the end of the lifespan even for the same image forming apparatus 102.

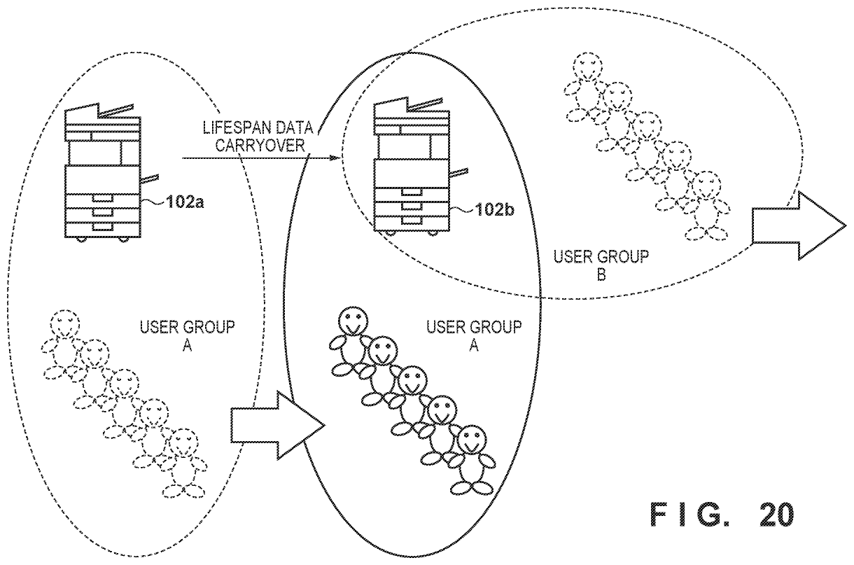

For example, assume that the image forming apparatus 102a is being used by a user group A, and the image forming apparatus 102b is being used by a user group B, as illustrated in FIG. 20. The user group A may then move to a different room and use the image forming apparatus 102b. In this case, the lifespan data of the image forming apparatus 102b obtained before the move date will indicate the usage amount of the user group B. Accordingly, if the lifespan data obtained before the move date is also applied to the user group A, the accuracy of predicting the replacement timing for the image forming apparatus 102b will drop. On the other hand, features of the usage amount of the user group A are reflected in the lifespan data 323 of the image forming apparatus 102a obtained before the move date. Accordingly, it is thought that carrying over the lifespan data 323 of the image forming apparatus 102a obtained before the move to the image forming apparatus 102b will improve the accuracy of predicting the replacement timing for the image forming apparatus 102b.

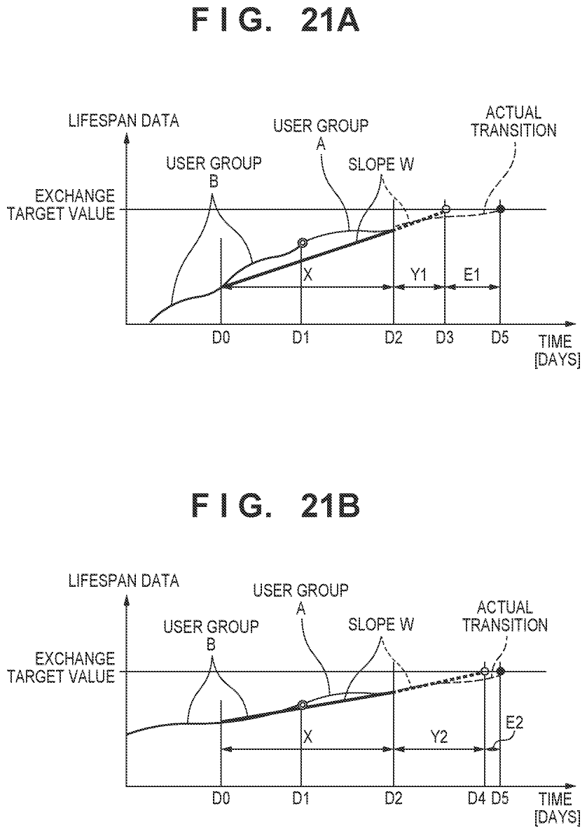

FIG. 21A illustrates a change in the lifespan data of the image forming apparatus 102b accompanying a change in a user group, according to a comparative example. The horizontal axis represents time. The vertical axis represents the lifespan data. D1 represents the date on which the user group using the image forming apparatus 102b changed from the user group B to the user group A. Accordingly, the lifespan data 323 obtained on the days previous to D1 reflects the actual usage by the user group B. The lifespan data 323 obtained on the days after D1 reflects the actual usage by the user group A. In this example, the usage frequency of the image forming apparatus 102b by the user group B is low, and the usage frequency of the image forming apparatus 102b by the user group A is high. D2 represents the date on which the prediction of the replacement timing was executed (the prediction date). DO represents a date X days previous to the prediction date. It is assumed that X days' worth of the lifespan data 323 is necessary for the prediction.

The prediction algorithm calculates the number of remaining days from the lifespan data 323 obtained in a period from the date D0 X days previous to the prediction date D2. Accordingly, if an environment change arises in the image forming apparatus 102b in the period from D0 to D2, prediction error E will increase. In this example, a predicted number of remaining days is Y1 (the replacement timing is D3), but the actual number of remaining days is Y1+E1 (the replacement timing is D5).

FIG. 21B illustrates a change in the lifespan data 323 of the image forming apparatus 102b accompanying a change in a user group, according to the third embodiment. In the third embodiment, the lifespan data 323 from the period before D1 is replaced with the lifespan data 323 generated by offsetting the lifespan data 323 of the user group A obtained by the image forming apparatus 102a. In other words, the lifespan data 323 of the user group A obtained by the image forming apparatus 102a is carried over to the image forming apparatus 102b. In this example, the predicted number of remaining days is Y2, and the predicted replacement timing is D4. Accordingly, the prediction error is reduced from E1 to E2.

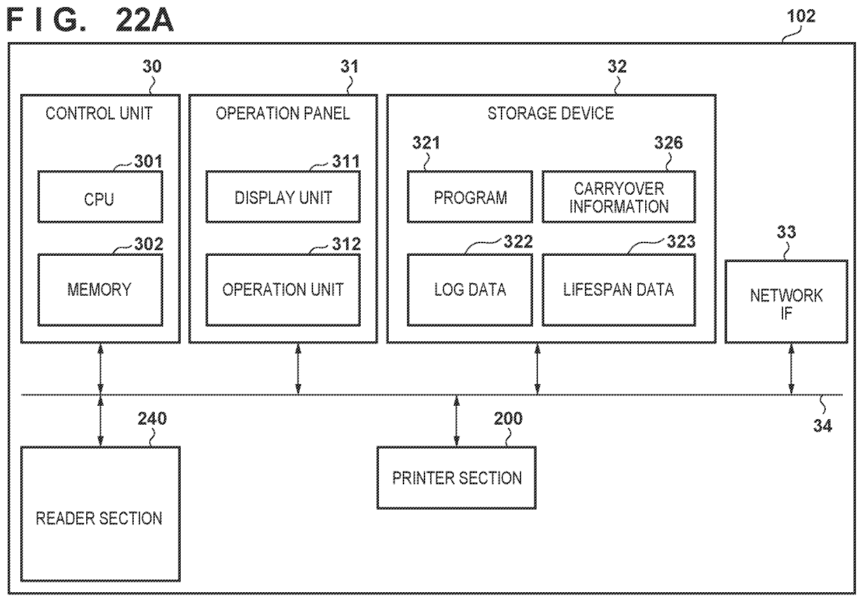

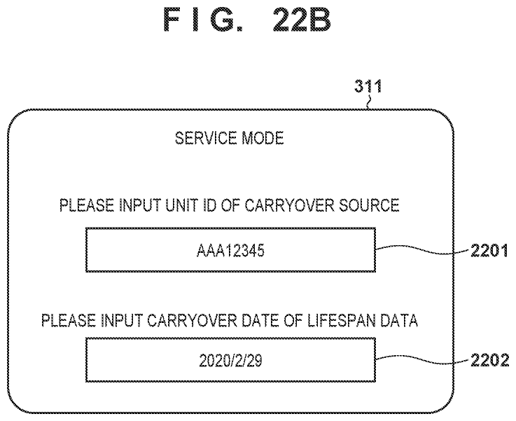

FIG. 22A illustrates the hardware configuration of the image forming apparatuses 102. Constituent elements already described will not be mentioned here. The storage device 32 stores carryover information 326. The carryover information 326 includes data of a carryover date, and a carryover source unit ID indicating the unit ID of the image forming apparatus 102a serving as a carryover source. Note that when the carryover is not executed, the carryover information 326 is not present, or the carryover information 326 is blank.

FIG. 22B illustrates an example of a user interface displayed in the display unit 311 of the carryover destination image forming apparatus 102b. An input field 2201 is a field that accepts the input of the unit ID of the image forming apparatus 102a serving as the carryover source. An input field 2202 is a field that accepts the input of the carryover date of the lifespan data 323 (D1 indicated in FIG. 21A). In other words, the carryover date is the date on which the user group using the image forming apparatus 102b changed from A to B. The CPU 301 of the image forming apparatus 102b stores the unit ID input to the input field 2201 in the service mode, and information on the carryover date input to the input field 2202, in the carryover information 326, and stores the carryover information 326 in the storage device 32.

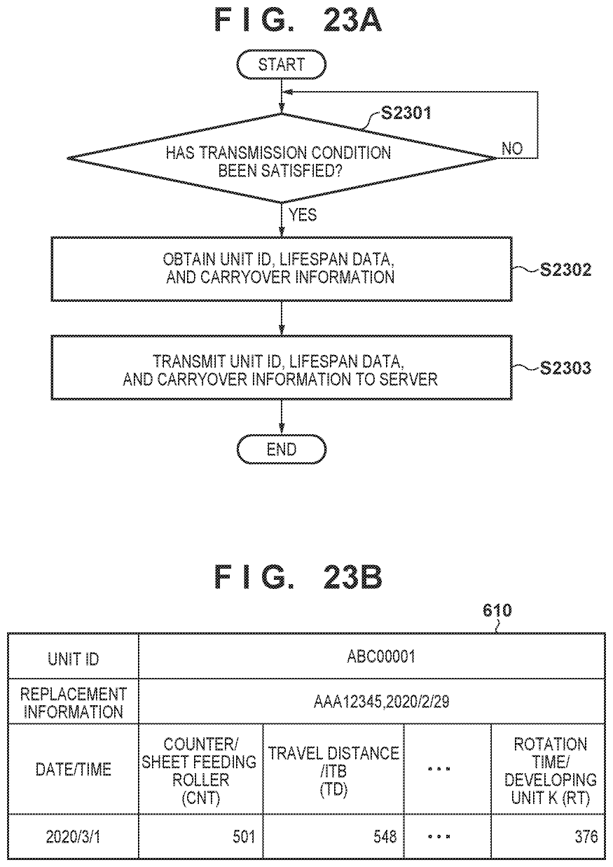

FIG. 23A illustrates processing executed by the CPU 301 in accordance with the program 321. In step S2301, the CPU 301 (the transmission determination unit 501) determines whether the predetermined transmission condition is satisfied. The transmission condition may be, for example, every set period, every day at 8:00 PM, or the like. The CPU 301 moves the processing to step S2302 when the transmission condition is satisfied. In step S2302, the CPU 301 (the data obtainment unit 502) obtains the unit ID, and the newest lifespan data 323 and carryover information 326, from the storage device 32. In step S2303, the CPU 301 (the data transmission unit 503) transmits the unit ID, the lifespan data 323, and the carryover information 326 to the server 103.

FIG. 23B illustrates an example of the data set 610 transmitted to the server 103. The unit ID is identification information of the image forming apparatus 102b (the carryover destination) that transmits the data set 610. In this example, “ABC00001” is stored in the unit ID. The carryover information 326 is the unit ID of the image forming apparatus 102a serving as the carryover source.

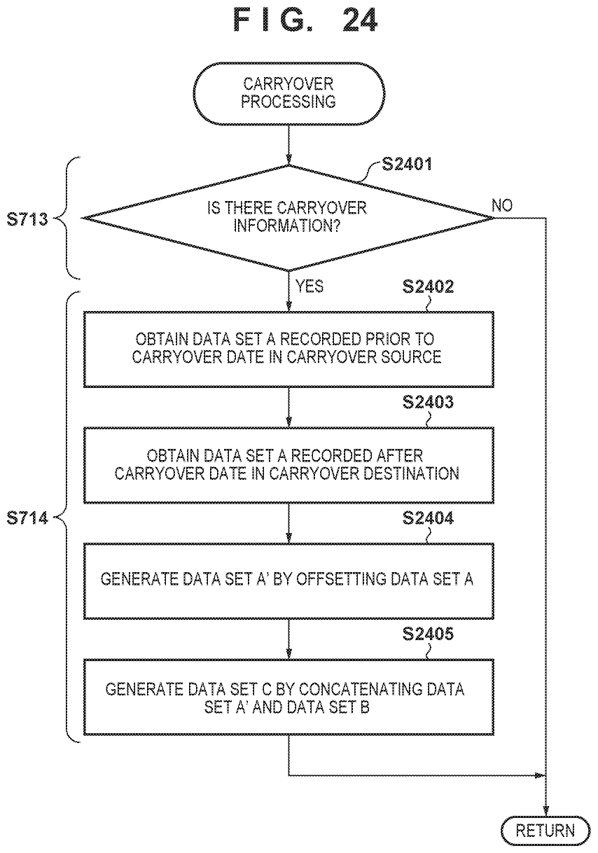

FIG. 24 illustrates the carryover processing according to the third embodiment. Note that the processing from step S2402 to step S2405 is executed for each consumable component.

In step S2401, the CPU 402 (the carryover unit 543) determines whether the carryover information 326 is present in the data set 610 of the image forming apparatus 102 subject to the prediction, obtained from the server 103. The carryover information 326 being present means that there is carryover information 326 and the carryover information 326 includes the unit ID of the carryover source and the carryover date. If the carryover information 326 is present, the CPU 402 moves the processing to step S2402. If there is no carryover information 326 present, the CPU 402 moves the processing to step S715.

In step S2402, the CPU 402 (the carryover unit 543) obtains, from the server 103, the data set A recorded by the carryover source before the carryover date. The data set A is temporarily stored in the memory 403.

In step S2403, the CPU 402 (the carryover unit 543) obtains, from the server 103, the data set B recorded by the carryover destination after the carryover date. The data set B is temporarily stored in the memory 403.

In step S2404, the CPU 402 (the carryover unit 543) obtains an offset amount from the data set A and the data set B, and generates the data set A′ by offsetting the data set A based on the offset amount. As described above, it is necessary to seamlessly concatenate the data set A and the data set B on the carryover date. Accordingly, a difference between the lifespan data of the carryover destination on the carryover date and the lifespan data of the carryover source on the day before the carryover date is calculated as the offset amount. The CPU 402 generates the data set A′ by adding the offset amount to the lifespan data for each day in the data set A.

In step S2405, the CPU 402 (the carryover unit 543) generates the data set C by concatenating the data set A′ and the data set B. As illustrated in FIG. 21B, in the data set C, the data set A′ of the lifespan data from the user group Ain the carryover source, and the data set B of the lifespan data from the user group A in the carryover destination, are concatenated seamlessly. The data set C is stored in the memory 403.

Then, in step S715, the CPU 402 (the prediction unit 544) predicts the consumable component replacement timing (number of remaining days) using the data set C stored in the memory 403. Usage trends (usage features) of the user group A from before the carryover date (the data carryover date) are reflected in the data set C, and thus the replacement timing (the number of remaining days) can be predicted accurately.

Technical Spirit Derived from Embodiments

### Aspect 1

The CPU 402 and the data obtainment unit 542 are examples of an obtaining unit that obtains operating information pertaining to an operation amount of an image forming apparatus (e.g., lifespan data). The CPU 402, the carryover unit 543, and the prediction unit 544 are examples of a predicting unit that predicts a replacement timing of a consumable component used in the image forming apparatus based on the operating information. The network IF 406 and the notification unit 545 are examples of an output unit that outputs information suggesting the replacement timing. The environment of a first image forming apparatus may be changed from a first environment to a second environment. In this case, the predicting unit carries over the operating information pertaining to the operation amount of a second image forming apparatus already used in the second environment and predicts the replacement timing of the consumable component for the first image forming apparatus that will now be used in the second environment. Through this, the replacement timing of the consumable component can be predicted accurately even if the environment of the image forming apparatus changes.

### Aspects 2 to 4

The environment of the first image forming apparatus changing from the first environment to the second environment can be called an “environment change”. The environment change can include the second image forming apparatus, which had been installed in the second environment, being replaced with the first image forming apparatus. The environment change can include the first image forming apparatus being added to the second environment. There are cases where the first image forming apparatus is being used by a first user group, and the second image forming apparatus had been being used by a second user group. In this case, the environment change can include the user group using the first image forming apparatus being changed from the first user group to the second user group. Note that the environment changes described here are merely examples. The environment change may be any environment change in which in order to execute prediction processing for an image forming apparatus after the environment change, the operating information obtained by another image forming apparatus before the environment change can be carried over.

### Aspects 5 and 6

The second image forming apparatus may be replaced with the first image forming apparatus. In this case, the carryover unit 543 functions as a generating unit that generates first operating information on the first image forming apparatus by carrying over second operating information on the second image forming apparatus. The carryover unit 543 offsets the second operating information from a period prior to the replacement date on which the second image forming apparatus is to be replaced with the first image forming apparatus. Furthermore, the carryover unit 543 may concatenate the offset second operating information to the first operating information obtained by the first image forming apparatus after the replacement date. Through this, the replacement timing of the consumable component can be predicted even more accurately.

### Aspect 7

The second operating information and the first operating information can each include a cumulative value of an operation amount of the consumable component (e.g., a count value, a travel distance, a rotation time). The carryover unit 543 subtracts the cumulative value of the operation amount of the consumable component in the second operating information on the replacement date from the cumulative value of the operation amount of the consumable component in the second operating information for each of the operation dates prior to the replacement date. As a result, the cumulative value of the operation amount of the consumable component in the second operating information on the replacement date becomes zero. The second operating information on each of the operation dates prior to the replacement date may be offset through this. Introducing such an offset makes it possible to seamlessly concatenate the operating information of the image forming apparatus subject to the prediction to the operating information of another image forming apparatus. Through this, the replacement timing of the consumable component can be predicted even more accurately.

### Aspect 8

When replacement information suggesting that the second image forming apparatus will be replaced with the first image forming apparatus is transmitted from the second image forming apparatus or the first image forming apparatus, the CPU 402 may generate the first operating information by carrying over the second operating information. Here, the “replacement information being transmitted” means that when the CPU 402 obtains the lifespan data and the like from the server 103, the replacement information is included therein.

### Aspects 9 and 10

The second image forming apparatus may be configured to transmit, to a server, the second operating information for each of operation dates. The CPU 402 may obtain the second operating information from the server based on the replacement information. The replacement information may include identification information of the second image forming apparatus, and may be transmitted from the first image forming apparatus. In this case, the CPU 402 will be able to easily identify the image forming apparatus that is the carryover source, based on the replacement information.

### Aspect 11

There are cases where the first image forming apparatus is added to a given environment. This, too, is one type of environment change. In this case, the CPU 402 may generate first operating information on the first image forming apparatus for a period prior to an addition date on which the first image forming apparatus is added to that environment, based on second operating information on the second image forming apparatus for a period prior to the addition date. Through this, the operating information on another image forming apparatus from before the addition date can be carried over, which will make it possible to accurately predict the replacement timing of the consumable component of the image forming apparatus which has been added.

### Aspects 12 to 14.

There are cases where the first image forming apparatus is added to a given environment. In this case, the CPU 402 may generate the first operating information for the period prior to the addition date based on the second operating information for the period prior to the addition date and third operating information on a third image forming apparatus already installed in that environment. Through this, the replacement timing of the consumable component of the image forming apparatus which has been added can be predicted accurately. In this manner, the carried over operating information may be obtained by a plurality of image forming apparatuses installed in the same environment. For example, there are cases where N image forming apparatuses including the second image forming apparatus are already installed in the environment. The CPU 402 may generate the first operating information for the period prior to the addition date based on operating information on each of the N image forming apparatuses for the period prior to the addition date. For example, the CPU 402 may obtain a sum of operation amounts of consumable components of the N image forming apparatuses for each of operation dates in the period prior to the addition date. Furthermore, the CPU 402 may generate the first operating information for each of the operation dates in the period prior to the addition date by dividing the sum by N+1. The CPU 402 may then concatenate the result to the first operating information from after the addition date. Through this, load distribution among the N+1 image forming apparatuses resulting from the addition of the image forming apparatus is taken into account. Accordingly, the replacement timing of the consumable component of the image forming apparatus which has been added can be predicted accurately.

### Aspect 15

The CPU 402 may offset the first operating information for a period prior to the addition date, the first operating information having been generated by carrying over the second operating information for the period prior to the addition date, and concatenate the offset first operating information to the first operating information from after the addition date. Through this, the data sets can be concatenated seamlessly, and thus the replacement timing of the consumable component of the image forming apparatus which has been added can be predicted accurately.

### Aspects 16 to 18

Addition information suggesting that the first image forming apparatus will be added to a given environment may be transmitted from the second image forming apparatus or the first image forming apparatus. In other words, the addition information may be transmitted from the image forming apparatus that is the carryover source, or may be transmitted from the image forming apparatus that is the carryover destination. The CPU 402 may generate the first operating information for the period prior to the addition of the first image forming apparatus to the environment by carrying over the second operating information. The CPU 402 may obtain the second operating information from the server 103 based on the addition information. The addition information may include identification information of the second image forming apparatus, and may be transmitted from the first image forming apparatus.

### Aspect 19

A user group using the first image forming apparatus may be changed from a first user group to a second user group. This, too, is one example of environment change. In this case, the CPU 402 carries over the second operating information pertaining to the operation amount of the second image forming apparatus which had been being used in the second user group, and predicts the replacement timing of the consumable component for the first image forming apparatus that will now be used in the second user group. Through this, the replacement timing of the consumable component can be predicted accurately.

### Aspect 20

The CPU 402 may be configured to predict the replacement timing using operating information spanning a predetermined number of days (e.g., X days) in order to predict the replacement timing. A “day of the change” is a day on which the user group using the first image forming apparatus is changed from the first user group to the second user group. As the first operating information on the first image forming apparatus spanning a predetermined number of days from the day of the change, the CPU 402 carries over the second operating information which was obtained previous to the day of the change and which spans a predetermined number of days from the day of the change. Note that this will make it possible to carry over the minimum necessary amount of data. For example, in the example illustrated in FIG. 21B, the lifespan data recorded on operation dates prior to DO may be excluded from the carryover processing.

### Aspects 21 and 22

As illustrated in FIG. 21B, the CPU 402 may offset the second operating information spanning a predetermined number of days from the day of the change, and concatenate the offset second operating information to the first operating information from after the day of the change. Through this, the replacement timing of the consumable component can be predicted accurately. An offset amount used in the offset may be a difference between an operation amount indicated by the first operating information on the day of the change and an operation amount indicated by the second operating information on the day before the day of the change. This will make it possible to seamlessly concatenate the data sets.

### Aspect 23

The information suggesting the replacement timing may be a recommended date, which is a date on which the consumable component is recommended to be replaced. Alternatively, the information suggesting the replacement timing may be a number of days remaining from a prediction date, which is a date when the replacement timing is predicted, to the recommended date. Alternatively, the information suggesting the replacement timing may be a number of days remaining from an output date, which is a date when the replacement timing is output, to the recommended date. This will make it easier for the maintenance inspector 106 to mobilize to replace the consumable component.

### Aspects 24 and 25

The program 540 is an example of a program that causes a computer to function as the obtaining unit, the predicting unit, and the output unit. The program 540 may be executed in the server 103, by the image forming apparatuses 102, or in a smartphone, a tablet computer, or the like. In this manner, the analysis apparatus 105 can be implemented in any computer capable of executing the program 540. The prediction system 10 is an example of an information processing system including an image forming apparatus and an information processing apparatus.

### Aspect 26

An information processing apparatus (e.g. server 103, analysis apparatus 105) comprising:

a communication circuit (e.g. network IF 406); and

a controller (e.g. CPU402) configured to:

obtain (e.g. S712) operating information related to an operation amount of an image forming apparatus through the communication circuit;

obtain (e.g. S712) another operating information related to another operation amount of another image forming apparatus located in a same installation location at which the image forming apparatus is located;

determine (e.g. S715), based on the operating information and the another operating information, a replacement timing for replacing a consumable component used in the image forming apparatus; and

output (e.g. S716) the replacement timing.

### Aspect 27

The information processing apparatus according to Aspect 26,

wherein the controller, in a case where the another image forming apparatus is to be replaced by the image forming apparatus, determines the replace timing based on the another operating information (e.g. S713-S715).

### Aspect 28

The information processing apparatus according to Aspect 26 or 27,

wherein the replacement timing includes a recommended date, which is a date on which the consumable component is recommended to be replaced.

### Aspect 29

The information processing apparatus according to Aspect 26 or 27,

wherein the replacement timing includes remaining days, after which the consumable component is recommended to be replaced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-205470, filed Dec. 17, 2021 which is hereby incorporated by reference herein in its entirety.

What is claimed is:

1. An information processing apparatus comprising:
a communication circuit; and
a controller configured to:
obtain operating information related to an operation amount of an image forming apparatus through the communication circuit;
obtain another operating information related to another operation amount of another image forming apparatus located in a same installation location at which the image forming apparatus is located;
determine, based on the operating information and the another operating information, a replacement timing for replacing a consumable component used in the image forming apparatus; and
output the replacement timing.

2. The information processing apparatus according to claim 1,
wherein the controller, in a case where the another image forming apparatus is to be replaced by the image forming apparatus, determines the replace timing based on the another operating information.

3. The information processing apparatus according to claim 1,
wherein the replacement timing includes a recommended date, which is a date on which the consumable component is recommended to be replaced.

4. The information processing apparatus according to claim 1,
wherein the replacement timing includes remaining days, after which the consumable component is recommended to be replaced.

5. An image forming system comprising:
a first image forming apparatus;
a second image forming apparatus; and
an information processing apparatus;
wherein the information processing apparatus further includes:
a communication circuit; and
a controller configured to:
obtain operating information related to an operation amount of the first image forming apparatus through the communication circuit;
obtain a second operating information related to a second operation amount of the second image forming apparatus located in a same installation location at which the first image forming apparatus is located;
determine, based on the first operating information and the second operating information, a replacement timing for replacing a consumable component used in the first image forming apparatus; and
output the replacement timing.

6. The image forming system according to claim 5,
wherein the controller, in a case where the another image forming apparatus is to be replaced by the image forming apparatus, determines the replace timing based on the another operating information.

7. The image forming system according to claim 5,
wherein the replacement timing includes a recommended date, which is a date on which the consumable component is recommended to be replaced.

8. The image forming system according to claim 5,
wherein the replacement timing includes remaining days, after which the consumable component is recommended to be replaced.
